(19) United States
(12) Patent Application Publication
(10) Pub. No.: US 2026/0350384 A1
(43) Pub. Date: Nov. 5, 2026

(54) Hardware-Efficient Separable Tensor Networks

(71) Applicant: Nintendo Co., Ltd., Kyoto (JP)

(72) Inventors: Alexandre DELATTRE, Paris (FR); Mickaël CORROYER, Paris (FR)

(21) Appl. No.: 19/232,419

(22) Filed: Jun. 9, 2025

Related U.S. Application Data
(60) Provisional application No. 63/797,938, filed on Apr. 30, 2025.

(51) Int. Cl. G06N 3/08; G06N 3/0495; G06T 3/4046

(52) U.S. Cl. CPC G06N 3/08; G06N 3/0495; G06T 3/4046

(57) ABSTRACT

A flexible-rank flexible-precision neural network architecture significantly reduces the number of parameters without creating a dimensional bottleneck. A low-precision quantization method quantizes weights of these neural networks to integer power-of-2 values while minimizing the induced loss of accuracy. These techniques in combination make it possible to obtain sparse but expressive neural networks with very low storage cost and inference time on a suitable hardware. A new NN architecture (GSTT) whose parameters are quantized to integer power-of-2 values with learnable/trainable power-of-2 quantization scales is designed to run on a dedicated hardware and can be used e.g. for upscaling, lossless/lossy compression, and any other task with a low-budget constraint that a regular neural network could perform.

### CROSS-REFERENCE TO RELATED APPLICATIONS

This application claims benefit of U.S. Provisional Patent Application No. 63/797,938 filed Apr. 30, 2025. This application also relates to copending commonly-assigned U.S. Provisional Patent Application No. 63/797,941 entitled “Lossless Neural Compression with Hardware-Efficient Separable Tensor Transform Networks” and US Patent Application No [symbol] , filed on even date herewith. These applications are incorporated herein by reference in their entirety and for all purposes.

### FIELD

The technology herein relates hardware-efficient Separable Tensor Transform (STT) networks and Grouped Separable Tensor Transform (GSTT) networks, with flexible rank and precision using a low-precision integer power-of-two quantization, that can be used for various tasks. Another aspect relates to image upscaling using these neural networks.

### BACKGROUND

Training and inference are common terms used in machine learning. At training time, neural network weights are updated at each step to minimize a certain measure of error (loss) over a set of input samples. At inference time, neural network weights are static and the user expects a good output coming from the neural network calculations. The inference input data are generally different from the training ones and the neural network has to generalize well over these new data.

### Example Low-Rank Approximation

In machine learning, the “perceptron” is an algorithm for supervised learning of binary classifiers. A binary classifier is a function which can decide whether or not an input, represented by a vector of numbers, belongs to some specific class. It is a type of linear classifier, i.e. a classification algorithm that makes its predictions based on a linear predictor function combining a set of weights with the feature vector.

In the below discussion of multilayer perceptrons, vectors are denoted by boldface lowercase letters (e.g., x), matrices are denoted by boldface capital letters (e.g., A) and tensors are denoted by boldface calligraphic letters (e.g., [symbol] ). Moreover, vectors will be represented as column vectors (vertically), which means that a vector x with n elements have dimensions n×1 (n rows, 1 columns) and its transposed vector x^{T} therefore have dimensions 1×n (1 row, n columns).

A multilayer perceptron is generally composed of several fully-connected layers—that is, all the neurons of a layer are connected to all the neurons of the next layer by weighted connections and these weights can be represented in the form of a matrix. A fully-connected layer of input dimension I and output dimension/has therefore as parameters a J×I weight matrix W (J rows and I columns) and possibly a J×1 bias vector b. See e.g., medium.com/@funcry/using-matrix-to-represent-fully-connected-layer-and-its-gradient-35604d99d138.

If we call the input vector x and the output vector z, the transformation performed by the layer amounts to applying an affine transformation (a linear transformation and a translation) on x, namely:

z=Wx+b

See FIG. 1 which shows example matrix and graph representations of a fully-connected layer with 3 inputs, 2 outputs and no bias.

Each fully-connected layer is usually followed by a non-linear activation function, such as a ReLU (rectified linear unit) activation function. The term “activation” alone usually refers to the output vector of the activation function which is then the input vector of the next fully-connected layer, here represented by x. It could also refer to the output of any layer, including a fully-connected layer. But let's leave the activation function aside for now.

Let us assume for simplicity that I=J=256 (i.e., the input vector x and the output vector z both have 256 elements) and that there is no bias vector. In this case the matrix W has dimensions of 256×256, that is 2¹⁶ elements, and represents a linear transformation from a 256-dimensional space to another 256-dimensional space. Such a 32-bit floating-point matrix already has a storage cost of 256×256×32=256 KiB and multiplying it with x involves 2¹⁶ multiplications, which is a huge computational cost. The idea of the low-rank approximation reduces the number of parameters in this type of layer while minimizing the impact on its expressiveness by decomposing the initial matrix W into an operation between several smaller matrices. Some example embodiments decide how many terms to keep in order to achieve a useful approximation, and then let the neural network training process make the most out of it.

A most naive approach, which has already been studied in many research papers, is based on the singular value decomposition (SVD) of a matrix. An J×I matrix W can be decomposed as a sum of outer products of vectors:

$$W = {\sum }_{i = 1}^{r} {u}_{i} ⊗ {v}_{i} = {\sum }_{i = 1}^{r} {u}_{i} {v}_{i}^{T}$$

with uᵢ a J×1 vector, vᵢ a I×1 vector and r≤min (I,J) the rank of the J×I matrix W. See FIG. 2A illustrating SVD as a sum of outer products of vectors.

A low-rank approximation then consists in truncating the sum by keeping the vectors corresponding to the highest singular values of the matrix W (in this example the pairs of vectors (uᵢ, vᵢ) with the biggest norm |uᵢ|²|vᵢ|²) to minimize the loss of information contained in this matrix. In a neural network, this concept can be exploited in several different ways, significant ones including:
Train a neural network whose linear layers are initially parameterized by K pairs of vectors (uᵢ,vᵢ)_{1≤i≤k} rather than an J×I matrix W with K≤min(I,J).
Train a neural network whose linear layers are initially parametrized by a J×I matrix W and add a regularization (penalty) on the singular values of this matrix, then perform a pruning phase at the end of the training by keeping the corresponding vectors at the highest singular values. (see e.g., towardsdatascience.com/regularization-in-deep-learning-11-12-and-dropout-377e75acc036).
Apply the previous method but perform pruning phases throughout the training at a well-defined interval.

In example non-limiting embodiments herein, we consider the first method because it has proven to be efficient and it facilitates the training loop, although the other two are also viable.

Regardless of the method chosen above, a neural network with such SVD-based layers will suffer from a certain lack of expressiveness. To show it, let us go back to our example for which I=J=256. The operation performed to obtain the output vector z is:

$$z = Wx = ( {\sum }_{i = 1}^{K} {u}_{i} {v}_{i}^{T} ) x = {\sum }_{i = 1}^{K} ( {u}_{i} {v}_{i}^{T} ) x = {\sum }_{i = 1}^{K} {u}_{i} ( {v}_{i}^{T} x )$$

where each intermediate operation

$${v}_{i}^{T} x$$

a scalar (a vector of dimensions 1× 1), which means that each operation

$$( {u}_{i} {v}_{i}^{T} ) x$$

temporary projects the input vector x into a 1-dimensional subspace. All the information contained in this vector is therefore reduced to a single number, which greatly constrains the expressiveness of the layer. One could compensate for this problem by summing 256 products

$${u}_{i} {v}_{i}^{T} ,$$

but the number of parameters would then be twice as large as the number of parameters contained in a single 256× 256 matrix. See FIG. 2B which shows intermediate dimensional reduction when multiplying an input vector with a sum of outer products.

### Related Work

Several works propose approximating a weight matrix of a neural network from a sum of Kronecker products rather than a sum of outer products, for various types of neural networks. For example, see Compression of Fully-Connected Layer in Neural Network by Kronecker Product (2015), Exploiting Local Structures with the Kronecker Layer in Convolutional Networks (2015), Compressing RNNs for IoT devices by 15-38x using Kronecker Products (2019), Compacter: Efficient Low-Rank Hypercomplex Adapter Layers (2021), As we generalized an SBT to an STT, some existing works also generalize the aforementioned method to a series of several Kronecker products, highlighting the link with the multilinear multiplication, but do not generally propose to add several series of Kronecker products or linear multiplication as in an STT. Here see Tensor Contraction Layers for Parsimonious Deep Nets (2017), Robust Kronecker Component Analysis (2018), Tensor Regression Networks (2020), Quantized Tensor Neural Network (2021), Variational Tensor Neural Networks for Deep Learning (2023).

For further research, the survey Tensor Networks Meet Neural Networks: A Survey and Future Perspectives (2023) gathered and analyzed many different works using tensor representations in neural networks.

### Quantization

Quantizing a neural network consists in numerically constraining its weights and activations to a more restrictive set of values. Generally, these weights and activations are real numbers represented as 32-bit floating-point numbers (FP32) but it is well known that computation speed efficiencies can be gained by restricting them for example to 8-bit integers (INT8), 4-bit integers (INT4), or even to ternary (−1,0,1) or binary numbers (−1,1). Reducing the precision (the number of bits in the binary representation) of the weights reduces the storage size of the model but also the computation cost (in terms of hardware cost and/or time) and memory usage during inference. Reducing the precision of the activations also reduces the computation cost and memory usage during inference. Essentially, if a weight is encoded on p bits and an activation is encoded on q bits, the hardware cost of multiplying the weight and the activation (which is the dominant cost at inference) is proportional to p×q.

There are two main attributes when discussing a numerical format. The first one is the range of representable numbers. The second one is how many values can be represented within the range, which in turn determines the resolution of the format (the distance between two numbers). For signed integer formats, the range is [−2^{b-1}, . . . , 2^{b-1}−1], where b is the number of bits to represent the numbers in memory. In this work the weights are quantized to a symmetric quantization range for INT8 the quantization range is [−127, . . . ,127] and for INT4 it is [−7, . . . ,7]. The number of representable values in [−(2^{b-1}−1), . . . , 2^{b-1}−1] is 2^{b}−1 which contrasts with FP32 where the range is and approximately 4.2× 10⁹ values can be represented. We can immediately see that FP32 is much more versatile, in that it is able to represent a wide range of distributions accurately. This is a nice property for deep learning models, where the distributions of weights and activations are usually very different, at least in terms of range. In addition, this range can differ between layers in the model.

To be able to represent these different distributions with an integer format, a scale factor s is used to map the range of floating-point values to the range the integer values. Let us take the example of the quantization of a fully-connected layer represented by a matrix of weights W. It is possible to have for example a scale for the whole matrix, a scale per line, or a scale per group of weights. This defines the quantization granularity. Suppose we have a scale for the entire matrix. A basic approach is to map the absolute maximum of the floating-point values to the maximum of the targeted integer values:

$$s = \frac{{f}_{max}}{{q}_{max}} = \frac{max ( \vert W \vert )}{{q}_{max}}$$

where:
   |·| represents the absolute value. When applied to a tensor (such as a matrix), this applies the absolute value to each element of the tensor.
qₘₐₓ is the maximum value in the quantization range (and −qₘₐₓ the minimal one).

Once the values are mapped in the correct range, all that remains is to round them to the nearest integer and truncate the values outside the quantization range. We can thus define our quantization operation that converts a floating-point value x to an integer q using a scale s:

$$q = clip ( ⌊ \frac{x}{s} ⌉ ; - {q}_{max} , {q}_{max} )$$

where:
└·┐ is the rounding operator that rounds a real value to its nearest integer using “bankers rounding” (rounding half to even). This prevents an overall upward or downward bias which is known to impact end-to-end inference accuracy in neural networks, as explained in Jacob et al, “Quantization and Training of Neural Networks for Efficient Integer-Arithmetic-Only Inference”, Google Inc. (2017) arXiv:1712.05877v1 doi.org/10.48550/arXiv.1712.05877
clip (·;−qₘₐₓ,qₘₐₓ) is an operator that sets any value outside the quantization range [−qₘₐₓ,qₘₐₓ] to 0 and leaves any value inside that range unchanged. The clip function ensures that no value is outside the stated quantization range.

To quantize our matrix W, we just need to calculate the scale s on the whole matrix and then apply the quantization above to each of its values.

### Quantization-Aware Training

A rather naive method to quantize a neural network consists in training the network with FP32 values then carrying out a calibration phase to calculate the scale factors and finally quantizing the weights and the activations brutally, i.e., using brute force. This method, called post-training quantization (PTQ), generally induces a loss in the model accuracy which becomes considerable for a low precision quantization.

Quantization-aware training (QAT) is a more efficient method that simulates the quantization during training to reduce the impact on the model accuracy of the actual quantization at the end of training. More precisely, QAT simulates low precision behavior in the forward pass, while the backward pass (backpropagation) remains the same. See e.g., towardsdatascience.com/neural-networks-forward-pass-and-backpropagation-be3b75alcfcc and towardsdatascience.com/understanding-backpropagation-abcc509ca9d0. This induces some quantization error which is accumulated in the total loss of the model and hence the optimizer (the algorithm minimizing the loss function) tries to reduce it by adjusting the parameters accordingly.

To simulate this quantization, example embodiments introduce “fake quantization” operations in the forward pass of the neural network training. Fake quantizing a value x simply consists in quantizing then dequantizing it by multiplying it by the scale to obtain a new floating-point number \tilde{x} more or less close to x:

$$q = clip ( ⌊ \frac{x}{s} ⌉ ; - {q}_{max} , {q}_{max} )$$

\tilde{x}=s·q

Putting these two equations together, we get:

$$\tilde{x} = s \cdot clip ( ⌊ \frac{x}{s} ⌉ ; - {q}_{max} , {q}_{max} )$$

Note that when the scale is calculated so as to map the absolute maximum of the floating-point values to the maximum of the quantization range, all the values of the matrix fall within the quantization range and therefore the clipping operation has no effect. FIG. 16 is a graphic example of the “fake quantization” of a matrix (of 10000 values). FIG. 16 shows step-by-step 4-bit “fake quantization” of a matrix of 10000 elements and plots the distribution of the matrix values as each step of the “fake quantization”.

This “fake quantization” is applied to the weights and biases just before they are applied to the input vector. For activations, the “fake quantization” is applied to the output vector of the following activation layer, which in our case is a ReLU function. The scale is usually calculated from an exponential moving average of the minimum and maximum of the activations so that it updates smoothly from several past data.

We can graph the quantized forward pass through a fully-connected and a ReLU layers as shown in FIG. 11, a training graph of QAT applied to a fully-connected and a ReLU layers.

A question is how to backpropagate the gradients through the rounding function in the quantization operation in order to update the model weights appropriately. This function is discrete-valued so its derivative is 0 almost everywhere. Therefore, using it as-is would severely hinder the learning process. An approximation commonly used to overcome this issue is the Straight-Through Estimator (STE) which simply sets the derivative to 1 everywhere which means that in the backpropagation the previous gradient is passed through the rounding function as-is. Thus, the derivative of the fake quantization is 1 inside the quantization range and 0 outside.

By way of illustration, FIG. 12 shows example backpropagation with a straight-through estimator. See e.g., github.com/matlab-deep-learning/quantization-aware-training.

Once the model is trained, it becomes possible to simply apply one last time the quantization operation to the model weights to obtain a fully-integer model. Example embodiments store the scale factors in the compressed file because they are used to dequantize the weights on the fly during the inference. To perform only integer operations during inference, these scales therefore are designed to be integers. There are several methods to handle this without degrading the model accuracy.

Generally, each ReLU layer is fused with the previous fully-connected layer such that all the scale factors used in these two layers during training are merged into one global scale factor at the end of the fused layer. Therefore, the intermediary output (before applying the scale factors) has a high precision (large values) but then the global scale factor is applied to rescale the output which is finally clipped to 0 outside the quantization range to obtain a low precision output.

FIG. 13 shows an example inference graph of 8-bit QAT applied to a fully-connected and a ReLU layers.

### Power-of-2 Quantization

Power-of-2 quantization has been explored in recent papers. In the two related papers Przewlocka-Rus et al, “Power-of-Two Quantization for Low Bitwidth and Hardware Compliant Neural Networks,” arXiv:2203.05025v1, doi.org/10.48550/arXiv.2203.05025 (2022) and Przewlocka-Rus et al, “Energy Efficient Hardware Acceleration of Neural Networks with Power-of-Two Quantisation” arXiv:2209.15257v1, Computer Vision and Graphics. Lecture Notes in Networks and Systems, vol 598. Springer, Cham (ICCVG 2022) doi.org/10.48550/arXiv.2209.15257, the authors propose a quantization scheme which quantizes them to real powers of 2 (not necessarily integers). The authors then introduce a “pruning factor” hyperparameter which determines the minimum threshold below which to set the values to 0. Some prior methods consist of learning the quantization range (e.g., optimizing by backpropagation of gradients, like the other model parameters) and calculating the scale factor as the absolute maximum of the input values, which is therefore a real value,

In one non-limiting aspect of example embodiments herein, in contrast, any such pruning threshold is implicit. By introducing a second rounding function into the quantization equation, non-limiting aspects of example embodiments herein set to 0 all quantized values less than 0.5 but, using the straight-through estimator we proposed, this quantization error is taken into account in the optimization process. Furthermore, in some non-limiting aspects of example embodiments herein, the quantization range is fixed, and the scale factor is learned and constrained to power-of-2 values.

Some other approaches propose power-of-2 quantization schemes that rely on the log-quantization introduced in Miyashita et al, “Convolutional Neural Networks using Logarithmic Data Representation” arXiv:1603.01025v2, doi.org/10.48550/arXiv.1603.01025 (2016).

Another approach is disclosed in Elhoushi et al, “DeepShift: Towards Multiplication-Less Neural Networks” Proceedings of the IEEE/CVF Conference on Computer Vision and Pattern Recognition (CVPR) Workshops (2021) arXiv:1905.13298v5, doi.org/10.48550/arXiv.1905.13298. This paper discloses several methods including “DeepShift-Q” which trains regular weights constrained to powers of 2. However, weights are not integer and no rescaling is performed at the time of quantization (which is equivalent to a fixed scale factor of 1). More recently, the rise of large generative models, especially large language models (LLMs), has led to a growing interest for model compression methods including low-precision quantization. Among the most popular methods are SmoothQuant, GPTQ and AWQ for LLMs, and SVDQuant for diffusion models. All these papers are focusing on quantizing large overparameterized models with billions of parameters that are therefore much less sensitive to low-precision quantization. Moreover, as these models are very long to train but robust to quantization and as quantization-aware training induces a significant additional training time, these works tend to focus on post-training quantization. Finally, they propose specific optimizations to reduce quantization error. On the other hand, researchers recently proposed BitNet, a 1-bit Transformer architecture for LLMs quantized with quantization-aware training, and BitNet b1.58 which is a ternary version of BitNet. As the aforementioned papers, these papers focus on quantizing large overparameterized models. They usually rely on a regular quantization scheme consisting of uniform quantization with floating-point scale factors as floating-point matrix multiplications are the main bottleneck on GPU which is the usual target device for these large models. The works cited above propose quantization schemes dedicated to well-known neural network architectures (fully-connected, convolutional).

### BRIEF DESCRIPTION OF THE DRAWINGS

FIG. 1 shows example matrix and graph representations of a fully-connected layer with 3 inputs, 2 outputs and no bias.

FIG. 2A shows an example SVD as a sum of outer products of vectors.

FIG. 2B shows an example intermediate dimensional reduction when multiplying an input vector with a sum of outer products.

FIG. 3A shows an example relationship between the matrices of an SBT layer and the matrix of the underlying fully-connected layer.

FIG. 3B shows how an example SBT layer applies a sum of matrix products on the input matrix X.

FIG. 4 shows an example 3^{rd}-order tensor representation. (Source: //hkilter.com/index.php?title=What_is_Tensor%3F)

FIG. 5 shows example fibers of a 3^{rd}-order tensor. (Source: Kolda et al, “Tensor Decompositions and Applications” SIAM REVIEW Society for Industrial and Applied Mathematics Vol. 51, No. 3, pp. 455-500 (2009) DOI. 10.1137/07070111X)

FIG. 6 shows example slices of a 3^{rd}-order tensor. (Source: Id.)

FIG. 7A shows an example relationship between the matrices of a 3^{rd}-order STT layer and the matrix of the underlying fully-connected layer.

FIG. 7B shows an example STT layer applying a sum of multilinear multiplications on the input tensor [symbol] .

FIG. 8 shows an example underlying fully-connected matrix (left column) and forward operation (right column) of example SVD and STT layers.

FIG. 9A shows a step-by-step representation of an STT term of order 2 (SBT) with 16×16 STT matrices.

FIG. 9B shows a step-by-step representation of a GSTT term of order 2 (GSBT) with 4 groups and 16×16 STT matrices.

FIG. 10 shows an example step-by-step 4-bit “fake” quantization of a matrix of 10000 elements.

FIG. 11 shows an example training graph of QAT applied to a fully-connected and a ReLU layers.

FIG. 12 shows example backpropagation with a straight-through estimator. (Source://github.com/matlab-deep-learning/quantization-aware-training)

FIG. 13 shows an example inference graph of 8-bit QAT applied to a fully-connected and a ReLU layers.

FIG. 14 shows an example mapping performed by a uniform quantization vs. an integer power-of-2 quantization for weights.

FIG. 15A shows an example step-by-step 4-bit fake quantization of a matrix (10000 values) containing outliers, with a calculated threshold.

FIG. 15B shows an example step-by-step 4-bit fake quantization of a matrix (10000 values) containing outliers, with a learned threshold.

FIG. 16 shows an example trained quantization thresholds move inward (left) or outward (center) to achieve range-resolution trade-off. When converged (right), positive and negative gradients compensate each other. (Source: Jain et al, “Trained Quantization Thresholds for Accurate and Efficient Fixed-Point Inference of Deep Neural Networks”, Proceedings of the 3rd MLSys Conference, Austin, TX, USA (2020), arXiv:1903.08066v3).

FIG. 17 shows example quantization-aware training of a GSBT network, optimizing it to upscale small image crops.

FIG. 18 shoes example ×2 upscaling workflow of a 1920×1080 YUV image. The Y channel is upscaled by the multiplication-free GSBT network whereas the U and V channels are upscaled by a bilinear upscaler.

FIG. 19 shows an example forward pass of an GSBT network upscaling a 4×4 image crop. The input is padded to be fed into the GSBT network that processes 16×16 matrices only, then only the relevant part of the output is kept.

FIG. 20 shows example comparison between bilinear upscaler and multiplication-free GSBT network upscaler on a x3 upscaling task.

FIG. 21 shows an example hardware and/or software implementation.

FIG. 22A shows another example hardware and/or software implementation.

FIG. 22B shows a more detailed implementation.

FIG. 23 shows an example hardware processing architecture.

FIG. 24 shows a block diagram of an example computer apparatus such as a video game system that may be used by a user to play a video game and which is designed to operate as and/or contain a decoder.

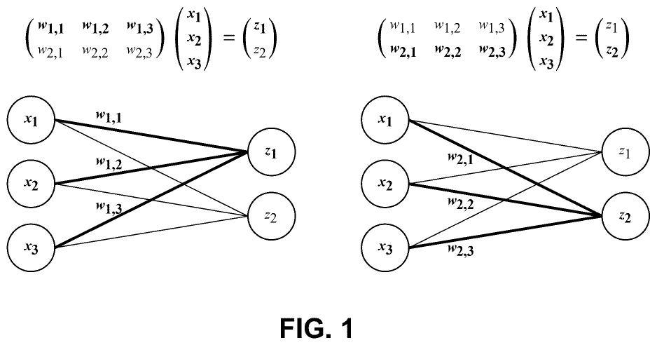

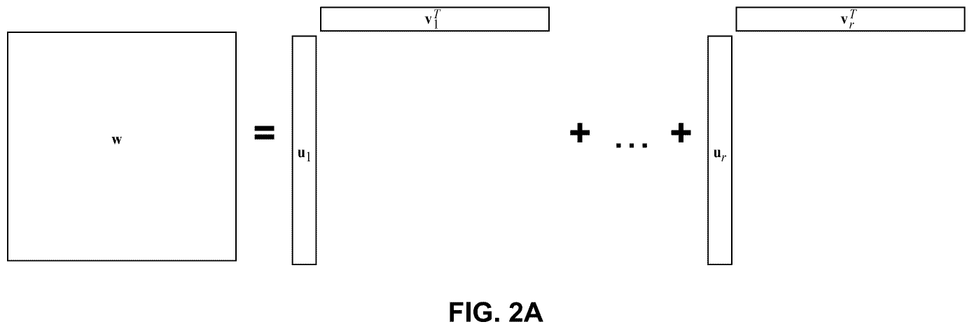

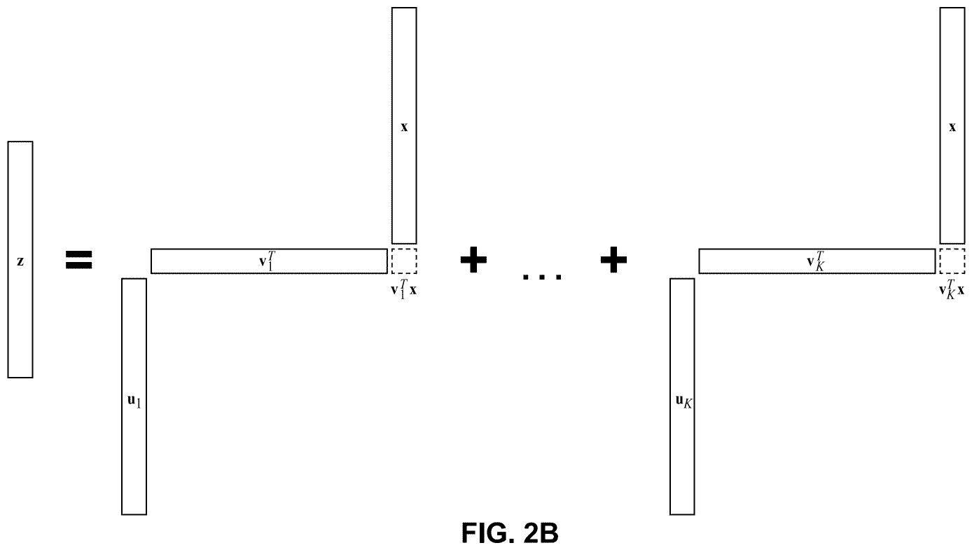

### DETAILED DESCRIPTION OF NON-LIMITING EMBODIMENTS

Example embodiments of the technology herein provide a new flexible-rank flexible-precision neural network architecture allowing to significantly reduce the number of parameters without creating a dimensional bottleneck. A low-precision quantization method is used to quantize these neural networks to integer power-of-2 values while minimizing the induced loss of accuracy. Moreover, the underlying rank and the precision of these networks are flexible and can be adjusted by summing more GSTT terms in each layer. These innovations make it possible to obtain neural networks with very low storage cost and inference time on a suitable hardware, while minimizing the induced loss of accuracy.

Example major achievements and innovations of non-limiting embodiments are:
A new flexible-rank neural network architecture generalizing SBT networks, namely Grouped Separable Tensor Transform (GSTT) networks, allowing to significantly reduce the number of parameters without dimensional bottleneck.
A fined-grained, hardware-efficient, power-of-2 quantization-aware training of this neural network architecture which allows a multiplication-free inference and a flexible underlying precision while minimizing the induced loss of accuracy.
Combined together, these two innovations make it possible to get hardware-efficient neural networks with both flexible rank and flexible precision which can be adjusted with the number of GSTT terms per layer. These neural networks have high expressiveness (i.e., ability to represent a wide variety of functions), low storage cost and low inference time. On dedicated hardware embodiments, they allow a low cost of computation, memory, and thus transistors (the main components of hardware computing units) with high parallelism.

Example embodiments are able to develop a customized or “bespoke” neural network trained to predict a specific input file or small set of input files. Various techniques described herein are used to reduce or minimize the size of the representation of this trained neural network so it can be efficiently stored and communicated from an encoder to a decoder, e.g., in the same data packets or package used to store and convey the encoded predicted error stream. This implementation becomes practical because trained neural networks can be so efficiently represented with reduced memory footprint across a variety of corresponding input files. In other words, the techniques described herein are not just a “corner case” that works for only certain types of data input files.

### Example Features

A device embodiment comprises a processor or processing circuit to perform operations comprising: reading an input file, and training a neural network on the input file, the neural network being configured to provide flexible precision and flexible rank by summing an adjustable number of Grouped Separable Tensor Transform (GSTT) terms in each layer of the neural network, the training further configuring the trained neural network to output/infer output data from input data.

In an embodiment, the operations further include: varying a number of GSTT terms across layers of the neural network to make a subset of the layers more expressive, and/or configuring GSTT tensor order and precision across layers of the neural network, and/or varying dimensions of STT matrices across GSTT layers of the neural network, and/or varying dimensions of STT matrices within a same GSTT layer of the neural network, and/or varying a number of GSTT groups across layers of the neural network, and/or varying a number of GSTT groups within a same layer of the neural network, and/or varying a number of layers of the neural network.

In an embodiment, all STT matrices of a same mode of a GSTT layer share a single quantization scale factor that is calculated through gradient-based optimization and quantized as a power-of-2 value.

In an embodiment, the adjustable number of GSTT terms for all layers of the neural network is set the same.

In an embodiment, the operations further include iteratively training the neural network using regularization & gradient-based optimization.

In an embodiment, the neural network is totally or partially quantized to integer power-of-2 values.

In an embodiment, the neural network represents an underlying fully-connected network that is sparse both in terms of rank and precision, and expressivity of the neural network is flexibly controlled by a single number K of GSTT terms in each layer of the neural network.

In an embodiment, the neural network receives an image as input and is trained to output an upscaled version of the image.

An embodiment of a device comprises a processor to perform operations comprising: receiving input data; using a hardware-circuit-based neural network to infer data from the received, the hardware-circuit-based neural network being configured to provide flexible-precision and flexible rank by summing an adjustable number of Grouped Separable Tensor Transform (GSTT) terms in each layer of the hardware-circuit-based neural network; and outputting the inferred data or data derived therefrom.

An embodiment further includes varying a number of GSTT terms across layers of the hardware-circuit-based neural network to make a subset of the layers more expressive, and/or configuring GSTT tensor order and precision across layers of the hardware-circuit-based neural network, and/or varying dimensions of STT matrices across GSTT layers of the hardware-circuit-based neural network, and/or varying dimensions of STT matrices within a same GSTT layer of the hardware-circuit-based neural network, and/or varying a number of GSTT groups across layers of the hardware-circuit-based neural network, and/or varying a number of GSTT groups within a same layer of the hardware-circuit-based neural, and/or varying a number of layers of the hardware-circuit-based neural network.

In an embodiment, the adjustable number of GSTT terms is set the same for all layers of the hardware-circuit-based neural network.

In an embodiment, the hardware-circuit-based neural network is totally or partially quantized to integer power-of-2 values.

In an embodiment, the hardware-circuit-based neural network is multiplication-free and performs integer-only arithmetic operations.

In an embodiment, the hardware-circuit-based neural network represents an underlying fully-connected network that is sparse both in terms of rank and precision, and expressivity of the hardware-circuit-based neural network is flexibly controlled by a single number K of GSTT terms in each layer of the hardware-circuit-based neural network.

In an embodiment, the hardware-circuit-based neural network receives an image as input and outputs an upscaled version of the image.

In an embodiment, the device comprises an application specific integrated circuit and/or a central processing unit and/or a graphics processing unit and/or a neural processing unit.

An embodiment of a method comprising performing, with a processor or processing circuit, operations comprising: reading an input file, and training a neural network on the input file, the neural network being configured to provide flexible precision and flexible rank by summing an adjustable number of Grouped Separable Tensor Transform (GSTT) terms in each layer of the neural network, the training further configuring the trained neural network to output/infer output data from input data.

In an embodiment, the operations further include: varying a number of GSTT terms across layers of the neural network to make a subset of the layers more expressive, and/or configuring GSTT tensor order and precision across layers of the neural network, and/or varying dimensions of STT matrices across GSTT layers of the neural network, and/or varying dimensions of STT matrices within a same GSTT layer of the neural network, and/or varying a number of GSTT groups across layers of the neural network, and/or varying a number of GSTT groups within a same layer of the neural network, and/or varying a number of layers of the neural network.

In an embodiment, all STT matrices of a same mode of a GSTT layer share a single quantization scale factor that is calculated through gradient-based optimization and quantized as a power-of-2 value.

In an embodiment, the adjustable number of GSTT terms is set the same for all layers of the neural network.

In an embodiment, the operations further include iteratively training the neural network using regularization & gradient-based optimization.

In an embodiment, the neural network is totally or partially quantized to integer power-of-2 values.

In an embodiment, the neural network represents an underlying fully-connected network that is sparse both in terms of rank and precision, and expressivity of the neural network is flexibly controlled by a single number K of GSTT terms in each layer of the neural network.

In an embodiment, the neural network receives an image as input and is trained to output an upscaled version of the image.

### Separable Block Transform (SBT)

It is possible to overcome the lack of intermediate expressiveness of SVD-based neural network layers by using a specific technique. The technique consists in reshaping the input 256× 1 vector x into a square 16× 16 matrix X and multiplying it on the left by a 16× 16 matrix Lᵢ and on the right by a second 16×16 matrix Rᵢ. The result: the intermediate product LᵢX and the total product LᵢXRᵢ are both 16×16 matrices. As these matrices contain 256 elements, we no longer have any dimension reduction and therefore no loss of expressiveness. For example, the identity layer (which yields the same output as the input) can be represented whereas it cannot be with the SVD approach. Thus, we have replaced a product of 3 vectors with an intermediate reduction to 1 dimension by a product of 3 matrices without intermediate dimension reduction. Another way to visualize this operation is that the Lᵢ matrix applies a linear transformation on the columns of X and the Rᵢ matrix on its rows.

Note that the matrices Lᵢ, Rᵢ respectively contain as many elements as the vectors uᵢ, vᵢ and the number of parameters therefore remains the same as in the first approach by SVD. Again, it is possible to sum several of these products within a layer to increase its expressiveness. It is also possible to reconstruct the underlying 256×256 matrix W using the Kronecker product:

$$W = {\sum }_{i = 1}^{K} {L}_{i} ⊗ {R}_{i}$$

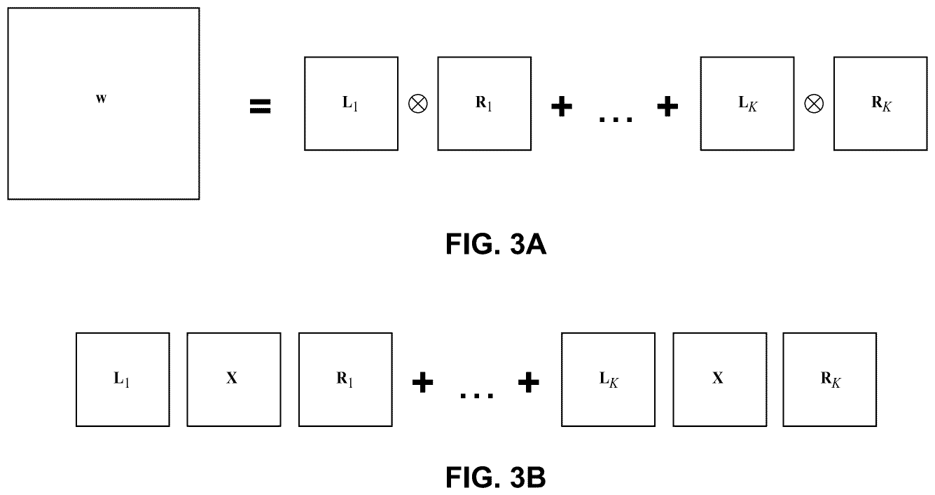

FIG. 3A shows an example relationship between the matrices of an SBT layer and the matrix of the underlying fully-connected layer.

As a generalization of the SVD, this decomposition of a matrix as a sum of Kronecker products is sometimes called the Kronecker Product Decomposition (KPD) (see for example Cai et al, KoPA: Automated Kronecker Product Approximation, Journal of Machine Learning Research Vol. 23, pages 1-44 (2022)).

There are therefore two ways to calculate the multiplication with the input vector x to obtain the output vector z:

$$z = Wx = ( {\sum }_{i = 1}^{K} {L}_{i} ⊗ {R}_{i} ) x = vec ( {\sum }_{i = 1}^{K} {L}_{i} {XR}_{i}^{T} )$$

where vec is the vectorization operator which corresponds to flattening a matrix into a vector by stacking its columns one below the other. The inverse operator vec⁻¹ is therefore the reshaping operator which transforms in this case the 256×1 vector x into a 16× 16 matrix X=vec⁻¹(x). Note that for the equation to be exact, the Rᵢ matrices are transposed. This equality comes from a property of the Kronecker product using a so-called “vectorization trick”:

(L⊗R)vec(X)=vec(LXR^{T})

FIG. 3B shows an example embodiment where the SBT layer applies a sum of matrix products on the input matrix X. This technique based on sound mathematics removes what might be termed a “dimensional bottleneck.”

This new type of layer architecture, in place of fully-connected layers, is described in U.S. Pat. No. 11,494,875 & U.S. Pat. No. 11,379,951 relating to “Separable Block Transform”, incorporated herein by reference. In such prior disclosures, a method for transforming signal data using a neural network is provided that includes populating an initial activation matrix with a plurality of values that are based on data from a plurality of samples from a source signal. Separable block transforms are then applied over multiple layers of the neural network. The separable block transforms are based on at least two matrices (L and R) for a single SBT and are applied to an input activation matrix to generate a corresponding output activation matrix. The initial activation matrix is used as the input activation matrix for a first layer of the multiple layers and the input activation matrix for each successive layer is the output activation matrix of a prior layer. The method further includes outputting the output activation matrix of the last layer of the neural network to generate a transformed signal that is based on the output activation matrix of the last layer.

For ease of explanation, we define the following terms for use below consistent with the above-cited patent disclosures:
“SBT”: the transformation explained above (in two different ways) that applies to a vector.
“SBT matrix”: a parameter matrix, such as Lᵢ or Rᵢ.
“SBT term”: a single pair of SBT matrices (Lᵢ, Rᵢ) and possibly the transformation associated with it.
“SBT sum”: a sum of SBT terms.
“SBT layer”: a neural network layer parameterized by a set of matrices (Lᵢ, Rᵢ)_{1≤i≤k} and possibly a bias and whose operation consists of an SBT sum.
“SBT network”: a neural network composed of SBT layers.

In one example embodiment, an SBT layer defined by a sum of K SBT terms contains K×2×16×16=K×2⁹ parameters and will involve K×2×16×16× 16=K×2¹³ multiplications. An equivalent fully-connected layer (in terms of input and output dimension) contains 2¹⁶ parameters and will involve 2¹⁶ multiplications. Thus, a layer with less than 128 SBT terms will contain fewer parameters than the corresponding fully-connected layer, and a layer with less than 8 SBT terms will also involve fewer multiplications. In this example, an SBT layer reuses its weights 16 times more than a fully-connected layer.

### Separable Tensor Transform (STT)

An SBT is actually just a special case (of order 2) of a more general transformation we have named “Separable Tensor Transform” (STT) Generally, these transforms can be used to transform matrices with a lot of numbers into matrices with fewer numbers. Fewer numbers helps with compression and encoding efficiency, memory footprint, complexity of compute, and other performance criteria. Furthermore, these numbers can be of any precision (e.g., floating point, integer, etc.)—and techniques are disclosed herein for reducing the precision cost of those numbers.

Adopting the same conventions as in the SBT section, we similarly define an STT matrix, an STT term, an STT sum, an STT layer and an STT network.

Before going into details, below are some mathematical definitions that will be useful.

### Tensors

As is well known, a tensor is a mathematical object that generalizes vectors and matrices to higher orders. The order of a tensor refers to the number of indices needed to specify a particular element of the tensor. Each of these indices allows access to a component of the tensor according to a different “dimension” or “axis”, but we rather speak of modes or ways. An N^{th}-order tensor can then be called a mode-N tensor or N-way tensor. For example, a scalar is a 0th-order (or mode-0, or 0-way) tensor because there is no need for indexing to access a unique value, a vector is a 1^{st}-order tensor, and a matrix is a 2^{nd}-order tensor because it takes two indices to specify each of its entries.

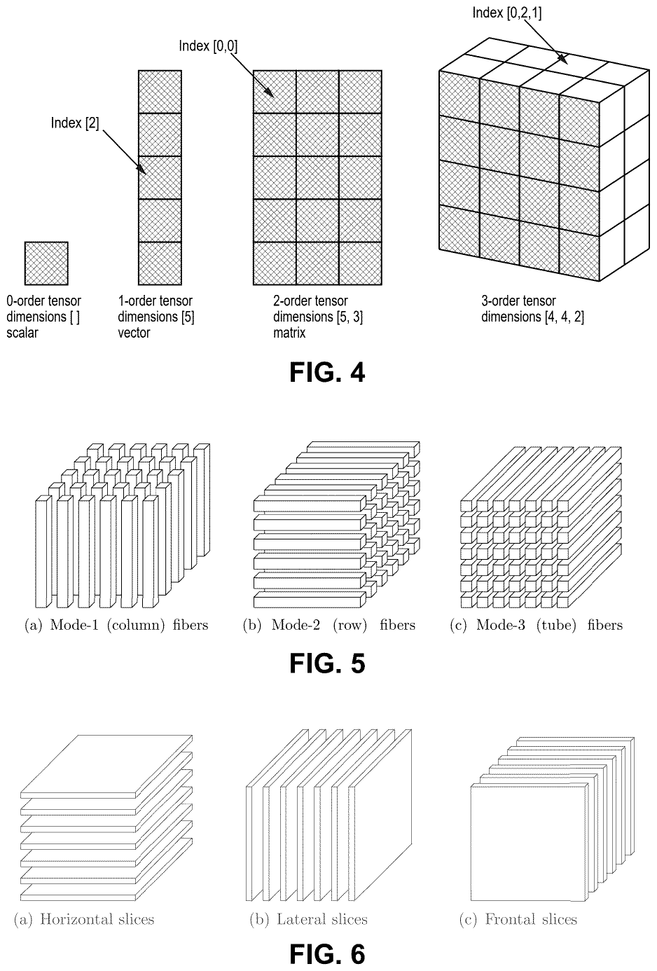

FIG. 4 shows visualization representations of a 0-order tensor (dimensionless), a 1-order tensor (dimension=5), a 2-order tensor (dimensions 5, 3) and a 3^{rd}-order tensor representation (dimensions 4, 4, 2). See e.g., hkilter.com/index.php?title=What_is_Tensor%3F.

The vectors contained in a tensor are called “fibers” and the matrices contained in a tensor are called “slices”. FIG. 5 shows fibers of an example for a 3^{rd}-order tensor and FIG. 6 shows slices of a 3rd order tensor. In the examples shown, the fibers and slices have specific names such as column fibers, row fibers, tube fibers, horizontal slices, lateral slices and frontal slices. See e.g., www.kolda.net/publication/TensorReview.pdf.

We have seen that an SBT consists in applying two linear transformations on a matrix (a 2^{nd}-order tensor), respectively to its rows and columns. An STT generalizes this approach and consists in applying N linear transformations on an N^{th}-order tensor, each on the fibers of one of the N modes of the tensor.

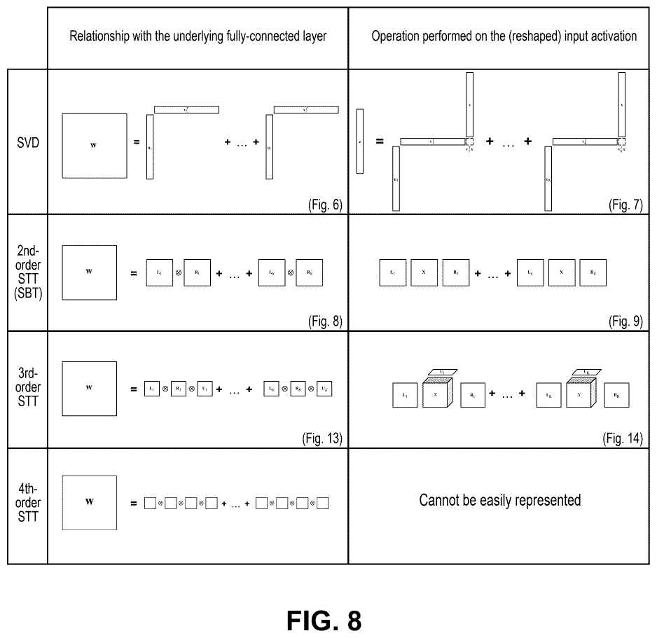

For example, the large weight matrix of a regular fully-connected layer may be replaced by a sum of Kronecker products of smaller matrices (not tensors, or let's say matrices are “order-2 tensors”), as shown in first column of FIG. 8. The tensor shape appears when we want to multiply the weights with the activation vector, here we need to reshape this vector as a tensor (right column of FIG. 8). So we rather decompose a linear transform into a sum of “groups” of smaller linear transforms (multilinear transforms).

### 3^{rd} Order Using STT

As a new example, suppose we have as input and output dimensions I=J=512. In the case of a fully-connected layer, this would require multiplying the 512× 1 input vector x by a 512×512 matrix W. Alternatively, we can reshape x into a 3^{rd}-order 8×8×8 tensor [symbol] . We can then multiply this tensor by three 8×8 matrices L, R, U (left, right, up) according to each mode of the tensor. This amounts to applying a first linear transformation on the columns of the tensor then a second on its lines and a third on its tubes. The tensor resulting from this operation is still an 8×8×8 tensor. Then we just need to vectorize it to get our 512× 1 output vector z.

This multiplication of a tensor [symbol] with a matrix A according to the n^{th} mode is called the n-mode matrix product and is noted: [symbol] ×ₙ A. It is possible to apply a series of n-mode matrix products according to different modes, in the desired order, which is called multilinear multiplication. So, in our example, we can denote the operation as the following multilinear multiplication:

[symbol]

×₁L×₂R×₃U

As for the SBT architecture, it is possible to sum several of these operations in order to increase the expressiveness of the layer. The underlying 512×512 matrix W could again be obtained using the Kronecker product:

$$W = {\sum }_{i = 1}^{K} {L}_{i} ⊗ {R}_{i} ⊗ {U}_{i}$$

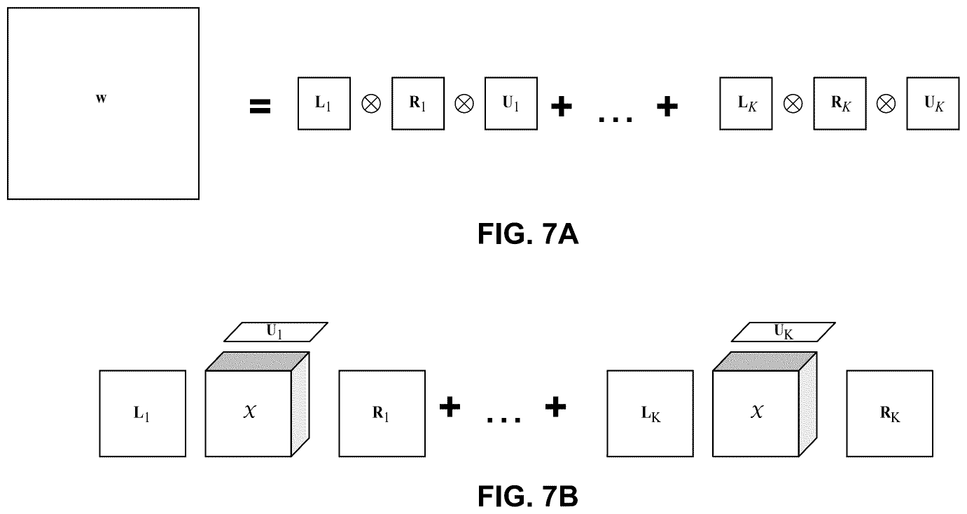

FIG. 7A illustrates the above and shows example relationship between the matrices of a 3^{rd}-order STT layer and the matrix of the underlying fully-connected layer.

The application of the STT layer on the 512×1 vector x can therefore be carried out in two different ways:

$$z = vec ( {\sum }_{i = 1}^{K} 𝒳 {\times }_{1} L {\times }_{2} R {\times }_{3} U ) = ( {\sum }_{i = 1}^{K} {L}_{i} ⊗ {R}_{i} ⊗ {U}_{i} ) x$$

where x=vec( [symbol] ).

FIG. 7B illustrates an example of how an example STT layer applies a sum of multilinear multiplications on the input tensor [symbol] .

The second method involves storing the intermediate 512×512 matrices Lᵢ ⊗Rᵢ ⊗Uᵢ so the first approach may be preferable in terms of memory cost. Also note that by using the first method, it is possible for the vectorization to be applied only on the network output and the intermediate activations can remain in the form of tensors.

In this example, an STT layer defined by a sum of K 3^{rd}-order STT terms contains K×3×8×8=K×192 parameters and will involve K×3×8×8×8=K×1536 multiplications. A fully-connected layer with a 512×512 matrix contains 2¹⁸=262144 parameters and involves just as many multiplications. Thus, a layer of less than 262144/192≈1365 3^{rd}-order STT terms contains fewer parameters, and a layer of less than 262144/1536≈170 terms also involves fewer multiplications.

### N^{th} Order

We can generalize this reasoning, in a more formal way, to any order N. First, let's define some operations specific to tensors.

The n-mode matrix product of an N^{th}-order I₁× . . . ×I_{N} tensor [symbol] with a J×Iₙ matrix A is denoted by [symbol] ×ₙ A and results in another N^{th}-order tensor of dimensions I₁× . . . ×Iₙ₋₁×J×Iₙ₊₁× . . . ×I_{N}. Elementwise, we have:

$${( 𝒳 {\times }_{n} A )}_{{i}_{1} … {i}_{n - 1} {ji}_{n + 1} … {i}_{N}} = {\sum }_{{i}_{n} = 1}^{{I}_{n}} {x}_{{i}_{1} … {i}_{N}} {a}_{{ji}_{n}}$$

In other words, each mode-n fiber is multiplied by the matrix A. Note that the result of this operation is still an N^{th}-order tensor with no longer Iₙ but J mode-n fibers, that is the number of rows of the matrix A.

The mode-n matricization, or mode-n unfolding, consists in reshaping an I₁× . . . ×I_{N} tensor X into an Iₙ×(I₁ . . . Iₙ₋₁JIₙ₊₁ . . . I_{N}) matrix, denoted X₍ₙ₎, by arranging the mode-n fibers of [symbol] to be the columns of X₍ₙ₎. For an example, please refer to the section 2.4 of Kolda et al, Tensor Decompositions and Applications, Vol. 51, No. 3, pp. 455-500, SIAM REVIEW Society for Industrial and Applied Mathematics (2009) DOI. 10.1137/07070111X.

The n-mode matrix product can then be expressed in terms of unfolded tensors:

[symbol]

= [symbol] ×ₙA⇔Y₍ₙ₎=AX₍ₙ₎

A series of n-mode matrix products according to different modes is referred as multilinear multiplication. See e.g., en.wikipedia.org/wiki/Multilinear_multiplication. Note that the order of the products in a multilinear multiplication does not matter:

[symbol]

×ₘA×ₙB= [symbol] ×ₙB×ₘA(m+n)

Now, the operation performed by an N^{th}-order STT can be written and implemented in two ways:

$$z = vec ( {\sum }_{i = 1}^{K} 𝒳 {\times }_{1} {A}_{i}^{( 1 )} {\times }_{2} … {\times }_{N} {A}_{i}^{( N )} ) = ( {\sum }_{i = 1}^{K} {A}_{i}^{( 1 )} ⊗ … ⊗ {A}_{i}^{( N )} ) x$$

where x=vec( [symbol] ).

In the second approach, the underlying fully-connected matrix Wis reconstructed from Kronecker products:

$$W = {\sum }_{i = 1}^{K} {A}_{i}^{( 1 )} ⊗ … ⊗ {A}_{i}^{( N )}$$

As mentioned earlier, this method is not memory-efficient, so using the multilinear multiplication is preferable. Moreover, when chaining several layers, the intermediate activations can remain in the form of tensors so there is no need to vectorize them.

FIG. 8 summarizes the above and shows example underlying fully-connected matrix (left column) and forward operation (right column) of SVD and STT layers.

This method can be generalized to non-square STT matrices

$${A}_{i}^{( n )}$$

with different dimensions. To replace a fully-connected layer of input dimension/and output dimension J, it suffices to replace the J×I weight matrix W by a sum of N^{th}-order STT terms with

$${A}_{i}^{( 1 )} , … , {A}_{i}^{( N )}$$

of respective dimensions J₁×I₁, . . . , J_{N}×I_{N} such that I₁× . . . ×I_{N}=I and J₁× . . . ×J_{N}=J. The I×1 input vector x must then be reshaped into an N^{th}-order tensor [symbol] of dimensions I₁× . . . ×I_{N}. The tensor resulting from the series of n-mode matrix products will have dimensions J₁× . . . ×J_{N}, and after vectorization the output vector z is indeed of dimensions J×1.

In the Python programming language, the multilinear multiplication can be achieved with dedicated libraries such as TensorLy, or using the einsum functions (Einstein summation) from libraries such as NumPy or PyTorch. See e.g., numpy.org/doc/stable/reference/generated/numpy.einsum.html. Otherwise, it can be implemented from scratch by unfolding the tensor as explained above.

### Expressiveness

Increasing the number of terms in an STT layer makes it possible to represent a larger number of matrices W, because we add new degrees of freedom, and therefore represent more expressive fully-connected networks.

Now let's clarify what we mean by “rank” in the context of STT networks. We have seen that increasing the number of outer products of vectors in an SVD layer increases the rank of the underlying fully-connected matrix W. But what happens when we increase the number of STT terms in an STT layer? Note first that if the matrices of an STT layer have full (maximal) ranks, it only takes one STT term for the matrix W to have full rank. This can be easily deduced from the following property:

rank(A⊗B)=rank(A)rank(B)

An STT layer can therefore easily represent a fully-connected layer with a matrix W of full rank and increasing the number of STT terms in the layer does not necessarily increase the matrix rank of W.

Now, if we consider the output of Kronecker products between N matrices A₁⊗ . . . ⊗Aₙ as a 2N^{th}-order tensor (like a tensor product), this tensor can then be reshaped into a N^{th}-order tensor [symbol] . This N^{th}-order tensor could be also obtained by outer products of the vectorized matrices [symbol] =vec(A₁)⊗ . . . ⊗vec(Aₙ). Such a N^{th}-order tensor, which can be expressed as outer products of N vectors, is by definition a tensor of rank 1. Indeed, the rank of a N^{th}-order tensor corresponds to the smallest number of such outer products which can be summed to produce this tensor. A tensor [symbol] has therefore a tensor rank R if it can be written as:

$$𝒳 = {u}_{1}^{( 1 )} ⊗ … ⊗ {u}_{1}^{( N )} + {u}_{2}^{( 1 )} ⊗ … ⊗ {u}_{2}^{( N )} + … + {u}_{R}^{( 1 )} ⊗ … ⊗ {u}_{R}^{( N )}$$

According to this definition, summing N^{th}-order STT terms therefore makes it possible to increase the tensor rank of the underlying N^{th}-order tensor [symbol] . We can therefore define the STT rank of an N^{th}-order STT layer as the tensor rank of the N^{th}-order tensor [symbol] where:

$$𝒲 = {\sum }_{i = 1}^{K} vec ( {A}_{i}^{( 1 )} ) ⊗ … ⊗ vec ( {A}_{i}^{( N )} )$$

Note that this tensor [symbol] contains the same coefficients as the matrix W, it is simply a different ordering of these coefficients. In the 2^{nd}-order case, there exists a well-defined rearrangement operator [symbol] to represent this relationship (see for example KoPA or arxiv.org/pdf/1912.02392.pdf) or The Ubiquitous Kronecker Product)//core.ac.uk/download/pdf/82128039.pdf.

Increasing the STT rank of an STT layer, by summing more STT terms, therefore makes it possible to represent more matrices W, different from those representable by simply increasing the number of terms in an SVD layer. Note however that there are common subspaces among the spaces generated by an SVD layer and those generated by an STT layer.

### Weights Initialization

In an example embodiment, we initialize the weight matrices

$${A}_{i}^{( n )}$$

with a custom Kaiming initialization allowing to preserve the magnitude of the variance of the weights and the activations. For an N^{th}-order STT layer with K sums, each matrix

$${A}_{i}^{( n )}$$

is initialized from the following Normal distribution:

$${A}_{i}^{( n )} \sim 𝒩 ( 0 , {( \frac{2}{K} )}^{\frac{1}{N}} \frac{1}{fan\_in ( {A}_{i}^{( n )} )} )$$

where fan_in

$$( {A}_{i}^{( n )} )$$

corresponds to the number of rows in the matrix

$${A}_{i}^{( n )} .$$

### Grouped Separable Tensor Transform (GSTT)

Just as an SBT is a special case of an STT, an STT is a special case of an even more general transformation that we have named Grouped Separable Tensor Transform (“GSTT”).

Indeed, instead of multiplying all the fibers of a mode of the tensor [symbol] by the same STT matrix, it is possible to gather these fibers into groups and multiply each group of fibers by a different STT matrix. For a given mode n, mode-n fibers can be for instance grouped into pairs (assuming an even number of mode-n fibers). Each pair of fibers will be multiplied by a dedicated STT matrix. For a maximum number of groups, i.e., a group size of 1, each mode-n fiber will be multiplied by a different STT matrix. For a minimum number of groups, i.e., a single group, all mode-n fibers will be multiplied by the same STT matrix. So an STT is a GSTT with a single group for each mode. For each mode, there are as many STT matrices as groups so multiplying the number of groups by a factor k therefore multiplies the number of parameters by k. Note that the number of groups can vary for each mode and all the STT matrices corresponding to a same mode in a GSTT must have the same dimensions (in one embodiment).

To apply this GSTT on the activation tensor, the groups of fibers of the tensor [symbol] are stacked in a new mode and each group is multiplied by a different STT matrix. The groups of fibers resulting from these multiplications are then concatenated to recreate a new tensor of the same order as [symbol] but possibly with different dimensions if the STT matrices are not square matrices. This operation is then repeated for each mode of the tensor.

The GSTT is more complex than a simple STT term because it involves reshaping the tensor between each matrix multiplication but this is not very costly in terms of calculation time (and therefore training time) using an appropriate implementation, for example using Python PyTorch reshape and einsum functions for respectively the tensor reshaping and the “groupwise” matrix multiplications. Note that the aforementioned expressiveness analysis and weights initialization method for the STT architecture are still valid for the GSTT architecture.

As

$${A}_{i}^{( n )}$$

represents the mode-n STT matrix of the summand i of an STT,

$${A}_{i , j}^{( n )}$$

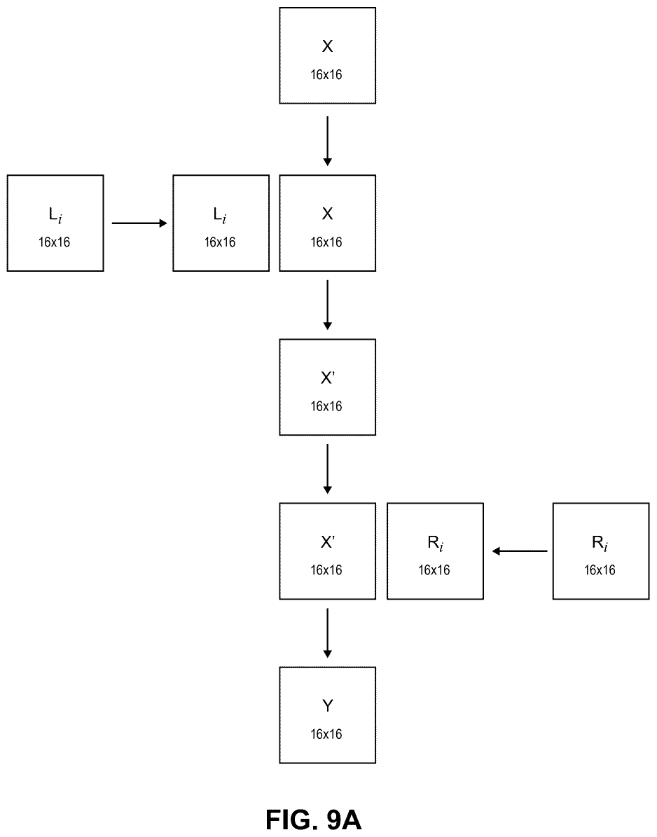

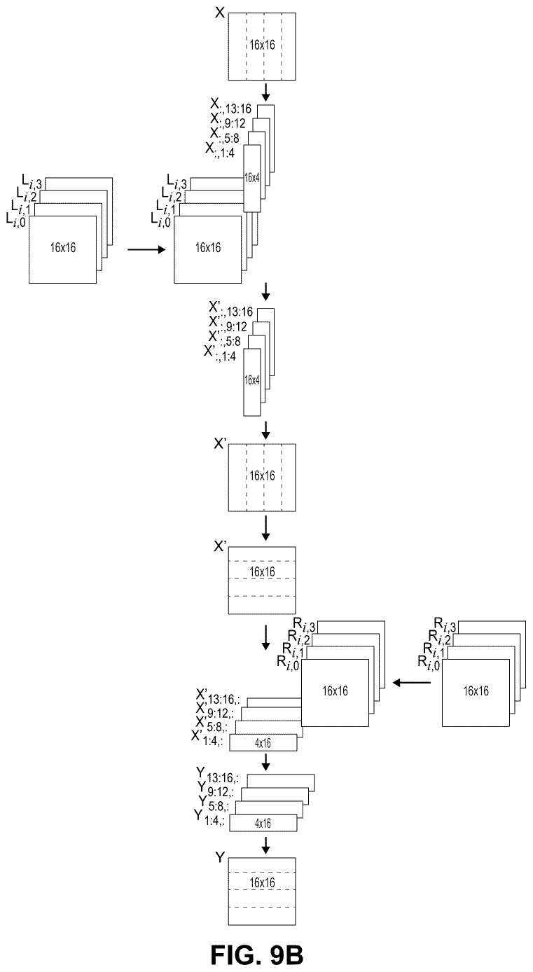

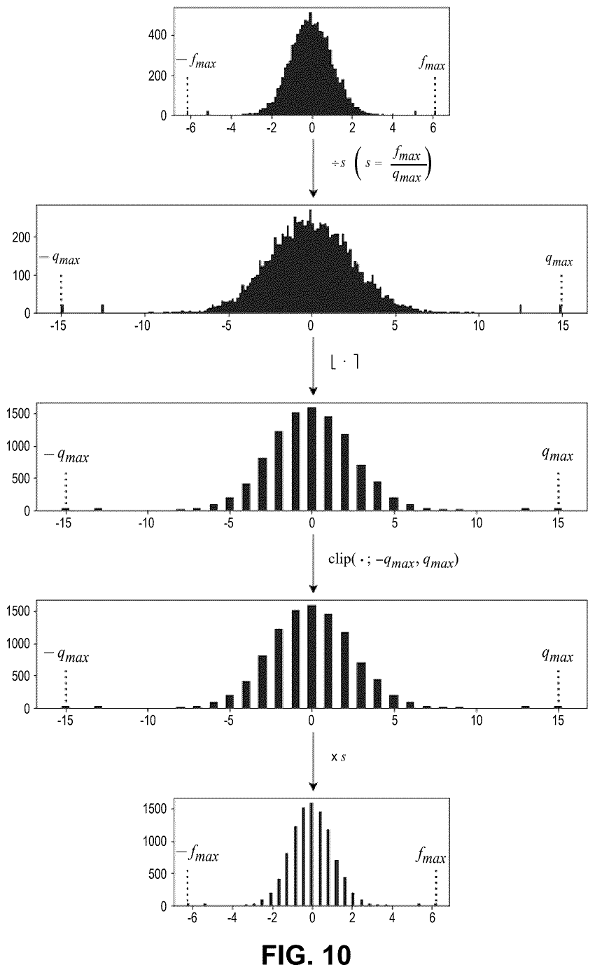

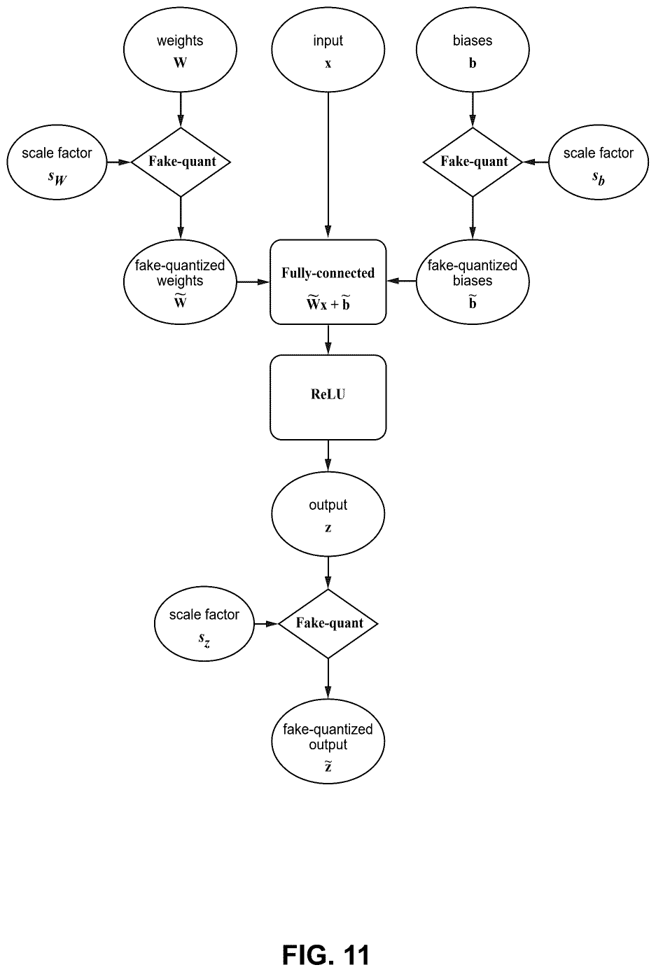

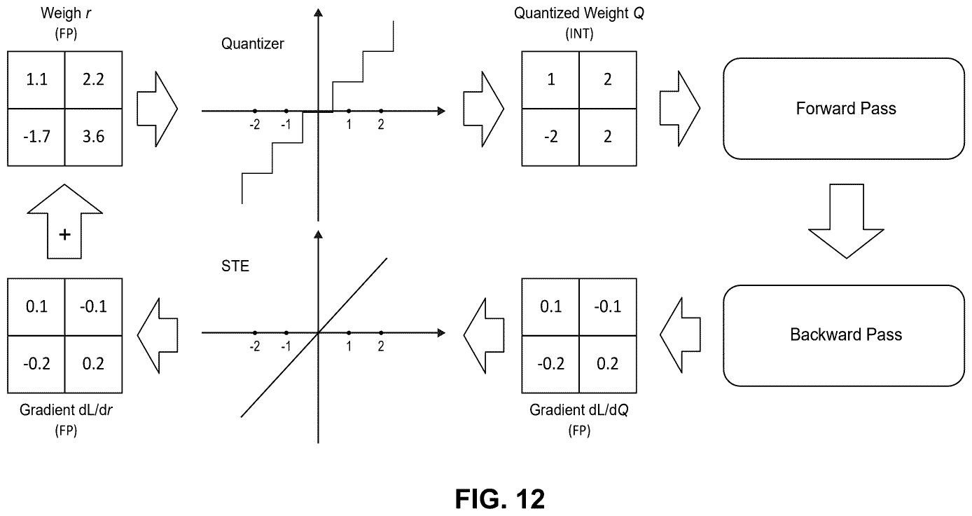

represents the mode-n STT matrix of the group j of the summand i of a GSTT. FIGS. 9A & 9B show example comparison between a SBT term and a GSBT term (2^{nd}-order GSTT term) with STT (or SBT) matrices Lᵢ, Rᵢ of dimensions 16×16. Specifically, FIG. 9A shows example step by step representation of an STT term of order 2 (SBT) with 16×16 STT matrices, and FIG. 9B shows example step by step representation of a GSTT term of order 2 (GSBT) with 4 groups and 16×16 STT matrices. The notations X_{i:j},: and X_{:,i:j} respectively represent all rows and columns of the matrix X between indices i and j included.

In contrast to aforementioned related work, example embodiments herein propose to perform a more general transformation (GSTT), namely a sum of multilinear multiplications between groups of fibers of the input activation tensor and weight matrices specific to each summand and each fiber group. GSTT networks offer more degrees of freedom to adjust the model expressiveness with a fine granularity according to computation, speed, and memory constraints. They can also be beneficial to increase expressiveness at a low additional computation cost using low-precision quantization.

In brief summary, in example embodiments, the number of STT terms are varied across layers of the neural network to make a subset of the layers more expressive, and/or STT tensor order and precision is configurable and can vary across layers of the neural network, and/or dimensions of matrices of the STT can vary across layers of the neural network, and/or dimensions of matrices of the STT can vary within a same layer of the neural network, and/or the number of layers of the neural network can vary, and generalizing the transforms to GSTTs provides additional flexibility by offering more degrees of freedom to adjust the model expressiveness with a fine granularity according to computation, speed, and memory constraints.

### Power-of-2 GSTT Networks

Example non-limiting embodiments of a method consists in quantizing the parameters of GSTT networks to low-precision integer power-of-2 values. An advantage of such power-of-2 values is that they can be mathematically multiplied and divided inexpensively simply by bit shifting hardware or other implementations, i.e., without the need for hardware multiplication or division hardware.

Moreover, it is possible to decompose any integer into a sum of smaller, power-of-2 components. If the basic matrix components are GSTT terms with powers-of-2 inside, selecting more of those terms provides the neural network with the flexibility to have more precision in the matrix world or more precision in the coefficient world. The optimization process does not have to choose between a precise matrix or precise scalar numbers. It can decide in some cases to have imprecise numbers but precise dimensional representation, or precise numbers and imprecise dimensional representation. These tradeoffs can be made independently for each layer on a layer-by-layer basis in a flexible way and is implemented in some embodiments to determining how many weights share the same scale. Such a ratio can be flexibly defined, with different parts of the neural network having different ratios. This decision provides flexibility about how good the matrix is and how precise the coefficients in the matrix are. It is also efficient to implement in hardware and can accommodate various constraints such as model size constraints, etc.

Example embodiments may thus totally or partially quantize to integer power-of-2 values. For instance, if we use biases in our NN, they are rather simply quantized to integer values. Moreover we could for example use the GSTT architecture with integer quantization, with both integer and power-of-2 layers, or even both non-quantized and quantized layers if we want a better precision on, let us say, the first and last layers.

Example embodiments implement a quantization-aware training (QAT) framework and scheme in which:
Scales are power-of-2 values of the form 2^{k} with k any (positive or negative) integer and are no longer calculated but optimized during the backpropagation (gradient-based optimization).
All STT matrices are quantized to integer power-of-2 values, i.e. 0 or values of the form 2^{k} with k≥0, which yields sets such as {0, ±1, ±2, ±4}, {0, ±1, ±2} or {0, ±1} and greatly reduces storage cost.
All mode-n STT matrices

$${A}_{i , \cdot }^{( n )}$$

in a summand i of a GSTT layer share a single quantization scale factor, no matter the number of groups.
Each bias vector has a scale and is uniformly quantized to integer values.
Each batch of activations has a scale and is uniformly quantized to integer values and multiplied with negative weights in a hardware-efficient way.

We detail each of these points in the following subsections.

### Integer Power-of-2 Weights

To quantize the weights to integer power-of-2 values, simply tweak the quantization formula to change the quantization scale while allowing the value 0:

$$q = clip ( ⌊ sign ( x ) \cdot {2}^{⌊ {log}_{2} ( \frac{\vert x \vert}{s} ) ⌉} ⌉ ; - {q}_{max} , {q}_{max} )$$

$$\tilde{x} = s \cdot q$$

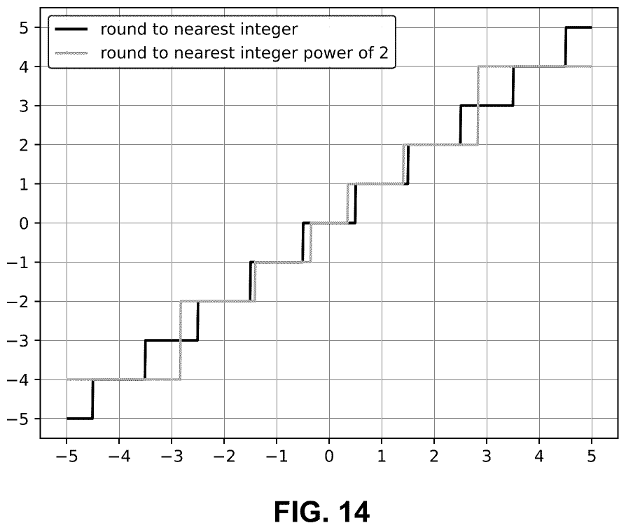

This quantization function consists in rounding a floating-point value to its nearest integer power of 2, including 0. We could also clip the values after the inner rounding (in the log domain) or multiply by the sign after the outer rounding and even the clipping, but in one example embodiment we choose this formula to be consistent with the linear quantization formula described previously. Note that the possible quantized values are not anymore uniformly distributed in the quantization range, which is called of non-uniform quantization as shown in FIG. 14 (mapping performed by a uniform quantization i.e., rounding to the nearest integer vs. an integer power-of-2 quantization i.e., rounding to the nearest integer power of 2).

During backpropagation, instead of applying a straight-through estimators to each rounding function, in one embodiment we apply a single straight-through estimator to the “round to nearest integer power of 2” function

$$x \text{?} ⌊ sign ( x ) \cdot {2}^{⌊ {log}_{2} ( \frac{\vert x \vert}{s} ) ⌉} ⌉ .$$

This is justified mathematically by calculating the partial derivatives of the fake-quantization function with respect to x and s. Moreover, we are only interested here in the partial derivatives inside the clipping range, so we will suppose there is no clipping.

Here are the partial derivates for the linear fake-quantization presented above:

$$\frac{\partial \tilde{x}}{\partial x} = 1$$

$$\frac{\partial \tilde{x}}{\partial s} = ⌊ \frac{x}{s} ⌉ - \frac{x}{s} = q - \frac{x}{s}$$

Now using the fake-quantization presented above with a straight-through estimator for each rounding function, the partial derivatives are:

$$\frac{\partial \tilde{x}}{\partial x} = \frac{s}{\vert x \vert} \cdot {2}^{⌊ {log}_{2} ( \frac{\vert x \vert}{s} ) ⌉}$$

$$\frac{\partial \tilde{x}}{\partial s} = ⌊ sign ( x ) \cdot {2}^{⌊ {log}_{2} ( \frac{\vert x \vert}{s} ) ⌉} ⌉ - sign ( x ) \cdot {2}^{⌊ {log}_{2} ( \frac{\vert x \vert}{s} ) ⌉}$$

Using the same fake-quantization but with a single straight-through estimator for the “round to nearest integer power of 2” function, the partial derivatives become:

$$\frac{\partial \tilde{x}}{\partial x} = 1$$

$$\frac{\partial \tilde{x}}{\partial s} = ⌊ sign ( x ) \cdot {2}^{⌊ {log}_{2} ( \frac{\vert x \vert}{s} ) ⌉} ⌉ - \frac{x}{s} = q - \frac{x}{s}$$

This second method provides partial derivatives with the same semantic as in the linear case while for the first method, the partial derivative

$$\frac{\partial \tilde{x}}{\partial x}$$

is not constant and the partial derivative

$$\frac{\partial \tilde{x}}{\partial s}$$

represents the quantization error only induced by the outer round but not the inner one. This means that, during training, the scale update will not take into account quantization errors due to the first rounding but only rounding errors of non-integer powers of 2 towards 0 during the second rounding. Although the second method is therefore preferable, note that in practice both methods work and provide fairly similar results.

### Power-of-2 Scales

As mentioned before, the way the scale is calculated can have a significant impact on quantization-aware training. Indeed, this is the only value that controls the range-resolution trade-off of the QAT.

Let us go back to the previous basic method to calculate the scale:

$$s = \frac{max ( \vert W \vert )}{{q}_{max}}$$

When we scale a matrix in this way, we ensure that all floating-point values in the matrix W are mapped into the quantization range [−qₘₐₓ,qₘₐₓ] and therefore no values are truncated. However, if the matrix contains outlying extreme values, these ones will completely bias the calculation of the scale and the resolution will be poor. To optimize this range-resolution trade-off in terms of model accuracy, the best option seems to be optimizing this parameter with respect to the loss function, i.e., in the same way as the other model parameters by a gradient-based optimization through backpropagation.

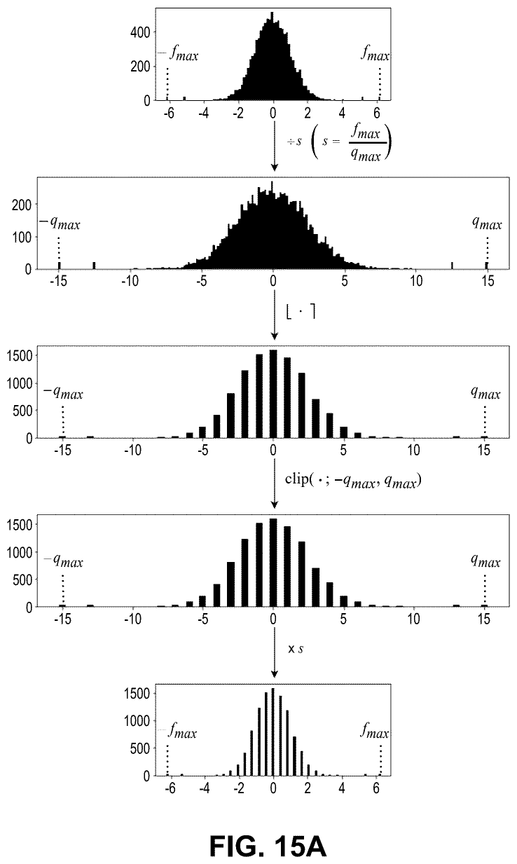

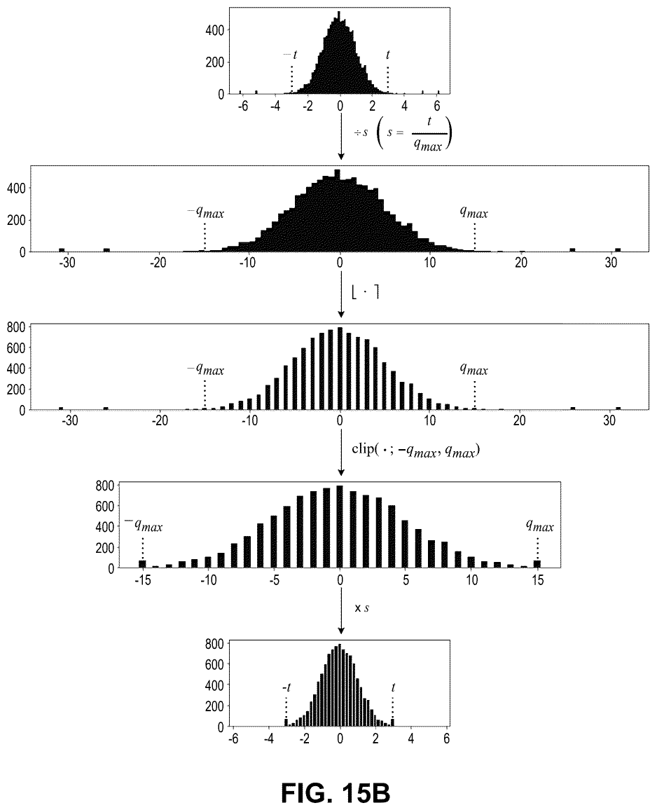

FIG. 15A shows an example step-by-step 4-bit fake quantization of a matrix (10000 values) containing outliers, with a calculated threshold. FIG. 15B shows the same fake quantization with a learned threshold.

Here max (|W|) actually represents the threshold value beyond which the initial floating-point values are truncated. Rather than directly optimizing the scale s as a model parameter, we optimize this threshold t. To optimize it as a power of 2, and for stability reasons, we optimize in practice the log-threshold T=log₂ (t), as proposed in Jain et al, “Trained Quantization Thresholds For Accurate And Efficient Fixed-Point Inference Of Deep Neural Networks” Proceedings of the 3rd MLSys Conference, Austin, TX, USA (2020). arXiv:1903.08066v3 [cs.CV] 28 Feb. 2020. This amounts to calculating s such that:

$$s = \frac{{2}^{⌈ T ⌉}}{{q}_{max}}$$

where ┌·┐ is the ceiling function and T is a model parameter optimized during backpropagation. As qₘₐₓ a power of 2, s is indeed a power of 2. There again, we use the Straight Through Estimator to backpropagate the gradients through the ceiling function.

To illustrate how optimizing this threshold optimizes the range-resolution trade-off, let's take the toy problem proposed in the aforementioned paper: a single quantizer optimized using a least-square-error loss L=(\tilde{x}−x)²/2with

$$\tilde{x} = s \cdot clip ( ⌊ \frac{x}{s} ⌉ ; - {q}_{max} , {q}_{max} )$$

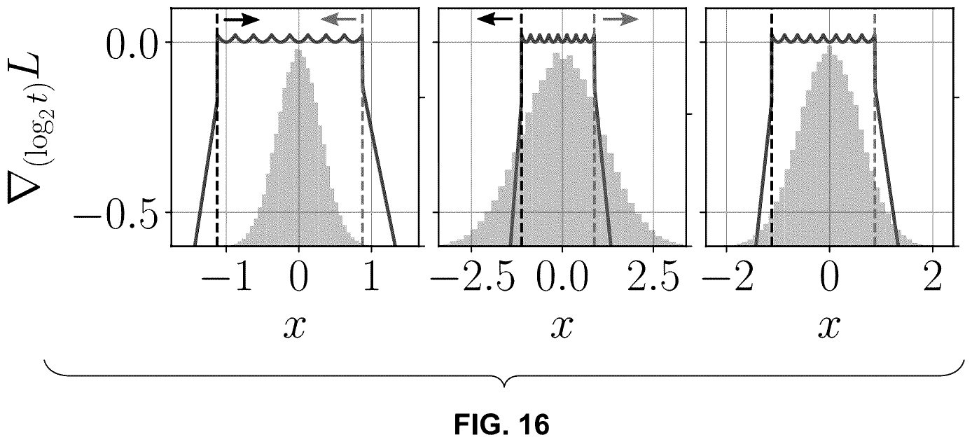

obtained by aforementioned linear fake-quantization. See e.g., www.investopedia.com/terms/l/least-squares-method.asp. Then we can plot the gradient of L with respect to the log-threshold T=log₂ (t) as shown in FIG. 16 (illustrating trained quantization thresholds moving inward (left) or outward (center) to achieve range-resolution trade-off. When converged (right), positive and negative gradients compensate each other). See also the above-referenced Jain et al paper.

We can see that for each value x to be quantized:
if it is outside the clipping region, then the gradient is negative (so the inverse gradient used in backpropagation is positive) and T is encouraged to increase to include this value inside the clipping region.
if it is inside the clipping region:
   if the scaled value x/s an integer, then the gradient is zero and T is not encouraged to move.
   otherwise, the gradient is proportional to the distance between the scaled value x/s and its quantized version

$$⌊ \frac{x}{s} ⌉ ,$$

so the larger this distance the more T is encouraged to decrease to densify (improve the resolution of) the quantization grid and bring the scaled value closer to its quantized version.

Thus, for a set of values, the threshold is optimized to solve a range-resolution tradeoff:
the values outside the clipping region encourage a larger clipping region to be included inside (larger range)
the values inside the clipping region encourage a smaller clipping region to get closer to their quantized version (higher resolution).

### Quantization Granularity

As mentioned before, all mode-n STT matrices

$${A}_{i}^{( n )}$$

in a summand i of a GSTT layer share a single quantization scale factor s, no matter the number of groups. This allows a rather fine quantization granularity while allowing merging of the scale factors in an efficient way at inference time as explained below. Thus, a layer with a sum of K N^{th}-order GSTT terms, each one with a different number of groups Gᵢ is parameterized by K

$${\sum }_{n = 1}^{N} {G}_{n}$$

STT matrices and KN scale factors. It is also possible for each STT matrix to have its own scale factor to refine the granularity or, on the contrary, to share a scale factor for all the matrices corresponding to the same mode of the activation tensor, for all the matrices of the same GSTT term, or even for all the matrices of the GSTT layer.

### Activations

As noted above, the activations are quantized to an integer representation (INT8 or less) to minimize the compute and memory cost during inference. To do this, all the vectors in a batch coming out of an activation layer are quantized using a common scale whose threshold t is optimized as a power of 2. This is done similarly to the weights but a calibration period of a few forward passes is carried out to initialize the threshold t from an exponential moving average of the absolute maximum of the first activations.

Note that during inference these positive activations will be multiplied by (integer) power-of-2 weights which can be negative. However, in the binary representation system generally used (two's complement representation), multiplying an activation by a negative weight requires a computation time proportional to the precision (the number of bits) of the activation because of a carry propagation (like writing a multiplication of two numbers by hand). It is nevertheless possible to make the cost of this operation much lower and independent of the precision of the activation by using a one's complement representation and dropping the end-around-carry which induces an off-by-one error. As for quantization-aware training, this can be simulated during the training to minimize the impact on the model accuracy.

### Example Non-Limiting Benefits of Example Embodiments

In one non-limiting aspect of example embodiments herein, in contrast to related works introducing a pruning threshold, any such pruning threshold is here implicit. By introducing a second rounding function into the quantization equation, non-limiting aspects of example embodiments herein set to 0 all quantized values less than 0.5 but, using the straight-through estimator we proposed, this quantization error is taken into account in the optimization process. Furthermore, in some non-limiting aspects of example embodiments herein, the quantization range is fixed, and the scale factor is learned and constrained to power-of-2 values.

As mentioned before, related works focus on quantizing large overparameterized models. They usually rely on a regular quantization scheme consisting of uniform quantization with floating-point scale factors as floating-point matrix multiplications are the main bottleneck on GPU which is the usual target device for these large models. They do not appear to suggest a non-uniform quantization scheme, optimized for hardware implementation, which is applicable to models of any size. Nor do they appear to suggest a new quantized neural network architecture, namely an integer power-of-two GSTT architecture, providing flexibility on both the rank and the precision of the underlying fully-connected network, as described in the following section(s).

The quantization scheme disclosed herein, although applicable to these well-known architectures, fits particularly well with the GSTT architecture, providing flexibility on both the rank and the precision of the underlying fully-connected network, as described in the following section.

### Example Benefits

### Flexible Rank, Flexible Precision

An interesting property of quantized STT networks is that they represent fully-connected networks that are sparse (parsimonious) both in terms of rank and precision, and this double sparsity (and therefore the network expressivity) is flexible and can be controlled by a single number K, the number of STT terms in each layer (the number of summands in the STT sum).

As shown above, increasing the STT rank of an STT layer, by summing more STT terms, makes it possible to represent more matrices W different from those representable by simply increasing the number of terms in an SVD layer.

On the other hand, if we reconstruct the quantized matrix W from the quantized STT terms, the higher the number of terms in the STT sum, the higher the precision of the matrix W. Another way to see it is that any integer matrix can be represented by a finite sum of power-of-2 matrices (weighted by power-of-2 scales factors), and even further by a finite sum of power-of-2 STT terms (weighted by power-of-2 scales factors).

Let us take the example of a layer composed of a single 2^{nd}-order STT term (SBT). As explained in the SBT section, this amounts to a double matrix product of the form LXR. Suppose that the matrices L and R are quantized in the range [−10, . . . , 10]. There then exists a decomposition of these matrices such that L=L₁+4L₂ with L₁ and L₂ having values in the set {0, ±1, ±2} only, and similarly for R. Indeed, any value of [−10, . . . ,10] can be represented as a+b with a in {0, ±1, ±2} and b {0, ±4, ±8}. We then have:

$$\begin{matrix}LXR = ( {L}_{1} + 4 {L}_{2} ) X ( {R}_{1} + 4 {R}_{2} ) \\ = {L}_{1} {XR}_{1} + 4 {L}_{1} {XR}_{2} + 4 {L}_{2} {XR}_{1} + 16 {L}_{2} {XR}_{2} \\ = {L}_{1} {XR}_{1} + 4 {L}_{2} {XR}_{2} + 4 {L}_{3} {XR}_{3} + 16 {L}_{4} {XR}_{4}\end{matrix}$$

with L, R in [−10, . . . ,10] and L₁, L₂, L₃, L₄ in {0, ±1, ±2}. Thus, a sum of 4 SBT terms quantized in {0, ±1, ±2} with power-of-2 scales can theoretically represent any SBT term quantized in [−10, . . . ,10].

Quantized STTs thus have flexible rank and flexible precision and implicitly represent fully-connected networks whose potential STT rank and precision increase as the number of summands (STT terms) increases (we assume that the precision of the STT matrices is fixed beforehand as a parameter).

Moreover, these STT networks offer several degrees of freedom on their expressiveness and their size such as the STT order, the number of terms per layer and the weights precision. It is therefore possible to drastically increase the number of inputs or outputs while keeping a small model, which could be useful in this context or a totally different one.

All these properties remain valid for GSTT networks. Besides, GSTT networks offer an additional degree of freedom which is the number of groups for each mode.

### Integer-Only Multiplication-Free Inference

An example non-limiting method herein allows an inference that involves no floating-point operation, no division requiring a conventional divider, and even no multiplication requiring a conventional multiplier. In example non-limiting embodiments, each STT or GSTT layer consists in multiplying an integer tensor by integer power-of-2 matrices. However, multiplying an integer by a power of 2 is an elementary operation at the hardware level, called bit shift, having a very low computational cost.

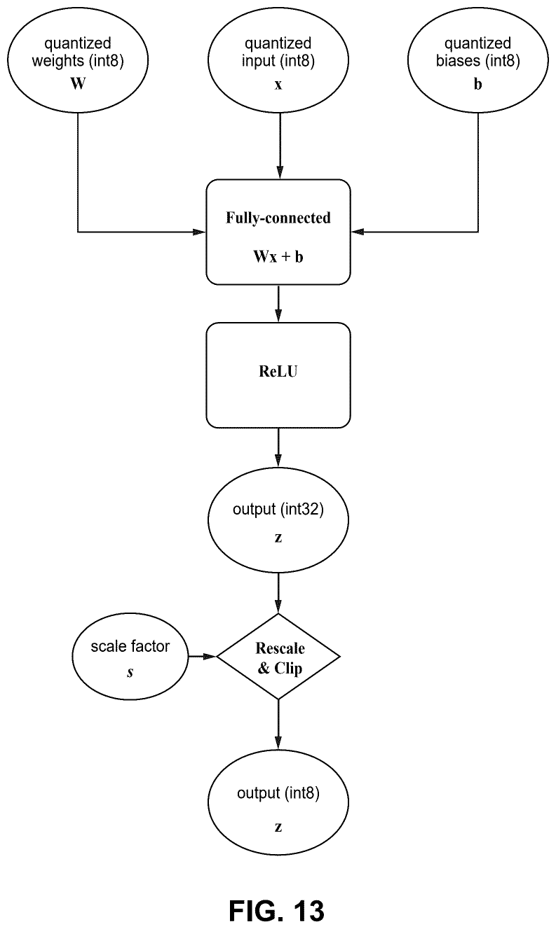

To perform such shifts, each integer power-of-2 matrix is first dequantized by multiplying it by its scale factor, but all the scale factors in a summand can be merged into a global scale factor which is still a power of 2. Therefore, dequantization implies bit shifts only too. The same goes for the dequantization of the bias which is then added to the intermediate result. To better control the precision of intermediate calculations, it is recommended to apply a quantization after each matrix product. Finally, the ReLU layer that follows is merged with the STT layer and then the output activation vector is rescaled using a power-of-2 scale factor and clipped. See FIG. 13.

In example embodiments, these power-of-2 networks are highly optimized because they only involve additions and bit shifts, which are the lowest level hardware arithmetic operations. For example, a multiplication is performed at the hardware level as a series of additions and bit shifts (see Booth's multiplication algorithm). Using an appropriate binary representation when multiplying activations by negative weights makes it possible to further reduce the inference time. As all these hardware-efficient operations are simulated during training, the impact on model accuracy is minimized. Another way to put it is that the model is trained using a hardware-aware training.

To minimize the inference time, it could be implemented on a dedicated hardware accelerator that would benefit from these optimizations, such as simply bit shifting when multiplying an integer by an integer power-of-2. Moreover, in an STT layer, the matrix multiplications and the reduction (summing the STT terms) can be highly parallelized using multi-operand carry-save adder trees, which are well-know and optimized primitives. See e.g., www.aoki.ecei.tohoku.ac.jp/arith/mg/algorithm.html. As these are the most expensive operations, the cost of the hardware implementation is dominated by these adder trees in terms of area, which is proportional to the number of transistors, and delay (propagation time), and therefore execution speed.

Thus, example non-limiting methods allow a hardware implementation with a low cost of computation, memory, and thus transistors/silicon area (the main components of hardware computing units).

### General-Purpose Architecture

These multiplication-free STT and GSTT networks are, by design, efficient for neural compression methods because they can have a very small storage size and allow fast decompression while maintaining good expressiveness. However, this type of hardware-efficient neural network can be beneficial for many other use cases, particularly those constrained by a low memory and/or computation budget. This constraint is ubiquitous in embedded devices. In addition, this architecture can replace a fully-connected network as well as a convolutional network. This last type of neural network is widely used in computer vision tasks.

A hardware (ASIC) implementing a multiplication-free GSTT network could thus be embedded into a portable device or an accessory such as a camera. It could make it possible to perform various low-cost image processing such as upscaling, denoising, detection or recognition of objects or faces, lossy compression, and many others.

### Example Use Case-Upscaling

The hardware-efficient architecture described above can be used in many use cases including upscaling, lossless compression and many more. In addition to neural compression, we tested and proved the effectiveness of multiplication-free GSTT networks for upscaling as another example use case. In one example upscaling method, we convert the input images from RGB (red, green, and blue channels) to YUV format. In the YUV model, the Y channel represents the luminance (or brightness) component, carrying most of the information, and the U, V channels represent the chrominance components. An image channel can be seen as a table of values (one per pixel), which is a matrix.

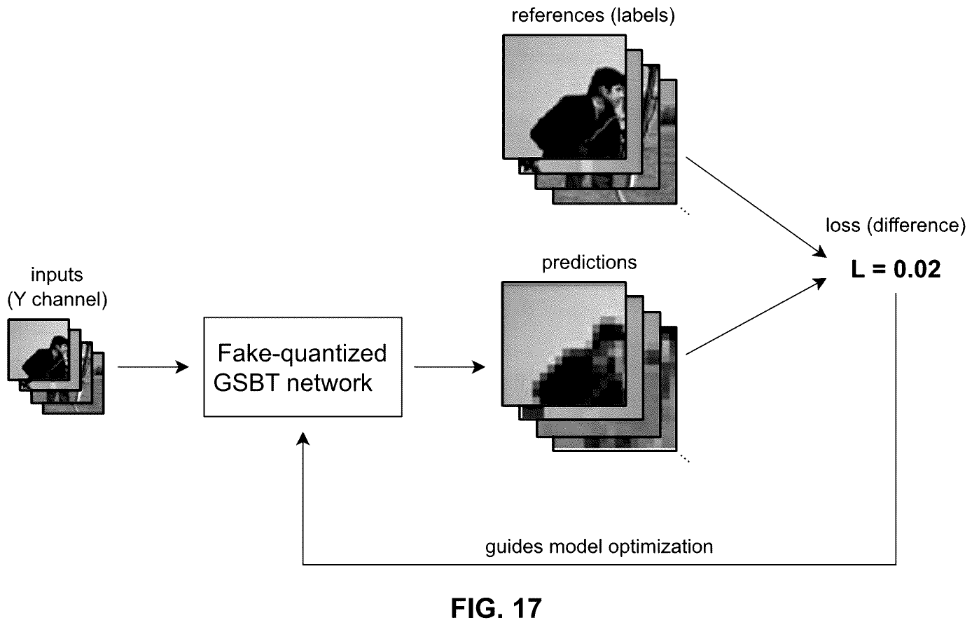

One example upscaling embodiment trains a GSBT (2^{nd}-order GSTT) network with ReLU activation functions to upscale small blocks (crops) from the Y channel of various images of a database (For background, see for example U.S. Pat. No. 11,494,875B2—“Systems and methods for machine learned image conversion”). To do so, it is possible to use a classic deep learning workflow, computing a loss value as the distance (difference) between the model prediction and the right high-resolution image (label, ground truth). This loss value is used by a gradient-based optimization algorithm to update the model parameters towards better values. Multiple loss functions can be used, but in practice one can obtain good results by combining a L1 or L2 loss with a perceptual loss. Moreover, we simulate quantization during training using the quantization-aware training scheme described previously. See FIG. 17.

Once the model is trained, we quantize it to obtain a multiplication-free GSBT network. To upscale an image at run time (inference), we convert the image to the YUV format, the Y channel is split into small blocks (of the same size as the ones used during training) that are upscaled independently by the neural network. The U and V channels, carrying less important information, are upscaled with regular bilinear upscale. Then the 3 channels are merged to reconstruct the upscaled YUV image that can be converted back to RGB format.

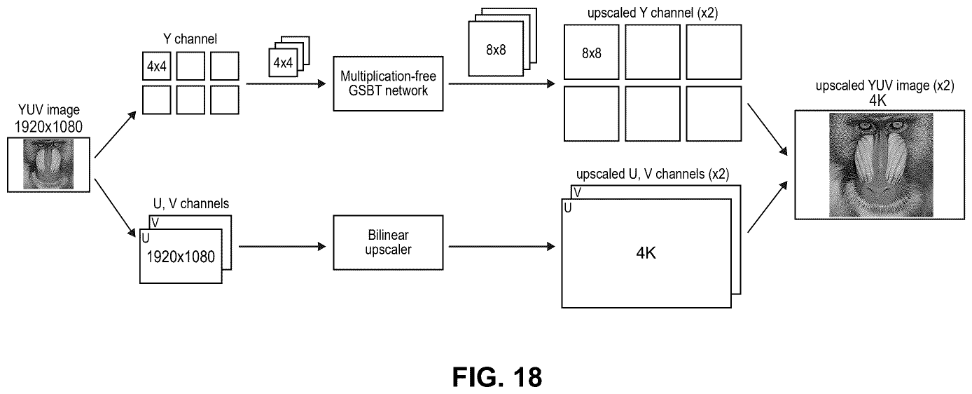

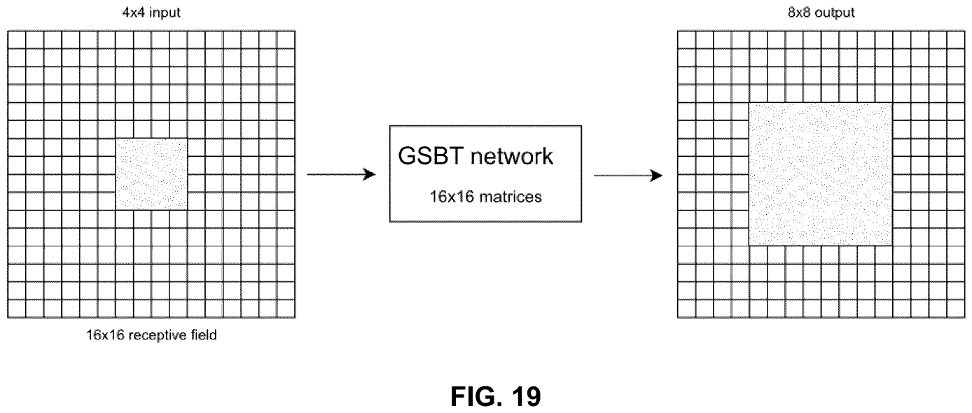

FIG. 18 is an example flowchart of an x2 upscaling, from 1080p to 4K resolution. In this particular example, the size of the SBT matrices can be fixed, for all the layers, to any value greater than the target block size (the size of the output and reference blocks). For example, let us say the input block size is 4×4 and the output one is 8×8 (×2 upscale). It is possible to use a GSBT network with 16×16 SBT matrices. All that needs to be done is to pad the input block (with zeros for example) to make it a 16×16 matrix, with the 4×4 submatrix of interest at the center, which will be passed to the SBT network. Then, the output will be a 16×16 matrix but the loss is computed between the reference 8×8 image block and the 8×8 submatrix at the center of the 16×16 output. Nevertheless, the SBT matrix size is important because it will define the receptive field of the neural network, which is basically the context of pixels the network can see to process the pixels of interest. See FIG. 19.

Using this method, it is possible to handle a large range of upscale ratios. Let's say the SBT matrices are 16×16. For example, to perform a x3 upscale one can provide the model with 4×4 blocks and compare its output to the 12×12 reference block. It is for example possible to upscale 3×3 blocks to 9×9 blocks, or even 1×1 blocks to 3×3 blocks. However, the smaller the input blocks, the higher the number of blocks to process and the longer the upscale phase. The size of the SBT matrices can be adjusted depending on the size of the output blocks.

As explained above, GSTT networks can be profitable on a dedicated hardware when quantizing the weights to a low precision and this is precisely the case here. Indeed, as weights are quantized to a very low precision, the additional silicon area needed to store new STT matrices is very small compared to the silicon area dedicated to compute matrix multiplications. Based on empirical analysis, it appears that in some contexts the network architecture providing the best trade-off between quality, speed and estimated silicon area for this upscale task is therefore the GSTT one with a maximum number of groups for each mode.

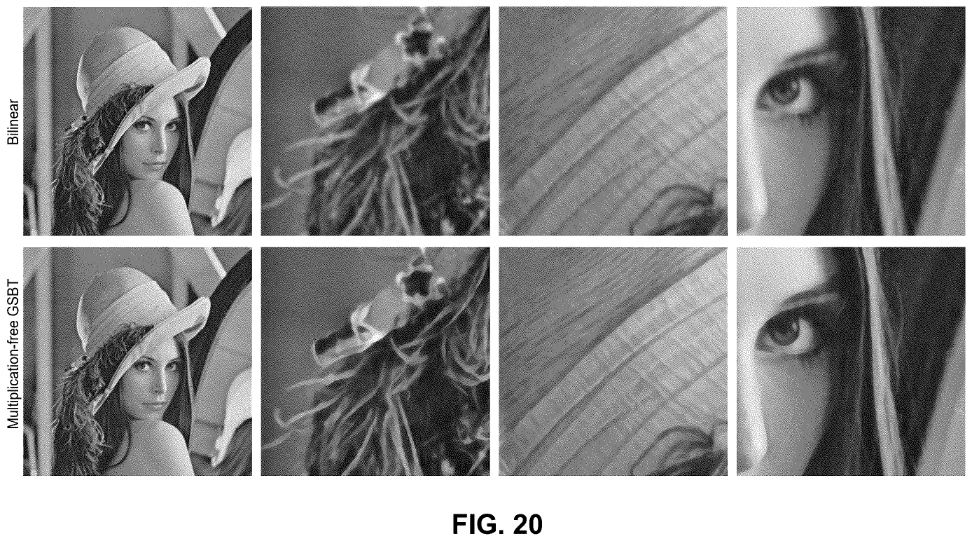

FIG. 20 shows an example of ×3 upscaling using a multiplication-free GSBT network with 16×16 SBT matrices and 16 groups for both modes, to upscale 4×4 blocks to 12×12 blocks, in comparison with a bilinear upscale.

### Example Optimizations

We advise to put more STT terms per layer than layers themselves. In other words, it is better to increase the expressiveness of the layers before increasing the number of layers. It is possible to vary the number of STT terms across the layers to make for example the first and the last layer more expressive, but in practice it seems sufficient to set the same value for all the layers.

Regarding the gradient-based optimization algorithm used to update the weights during backpropagation, Adam-like optimizers are a good solution. See e.g., machinelearningmastery.com/adam-optimization-algorithm-for-deep-learning/. Indeed, the performance of this type of optimizer no longer needs to be proven in the deep learning field but Adam also makes it possible, thanks to its momentums, to reduce oscillations of the floating-point values around the decision threshold, as explained in “Trained Quantization Thresholds for Accurate and Efficient Fixed-Point Inference of Deep Neural Networks” (https://arxiv.org/abs/1903.08066. See also e.g., machinelearningmastery.com/adam-optimization-algorithm-for-deep-learning/This phenomenon of oscillations has been studied in a more global way in Nagel et al, “Overcoming Oscillations in Quantization-Aware Training”, Proceedings of the 39 the International Conference on Machine Learning, Baltimore, Maryland, USA, PMLR 162, 2022, arXiv:2203.11086v2 [cs.LG] 28 Jun. 2022.

### Example Hardware Implementation

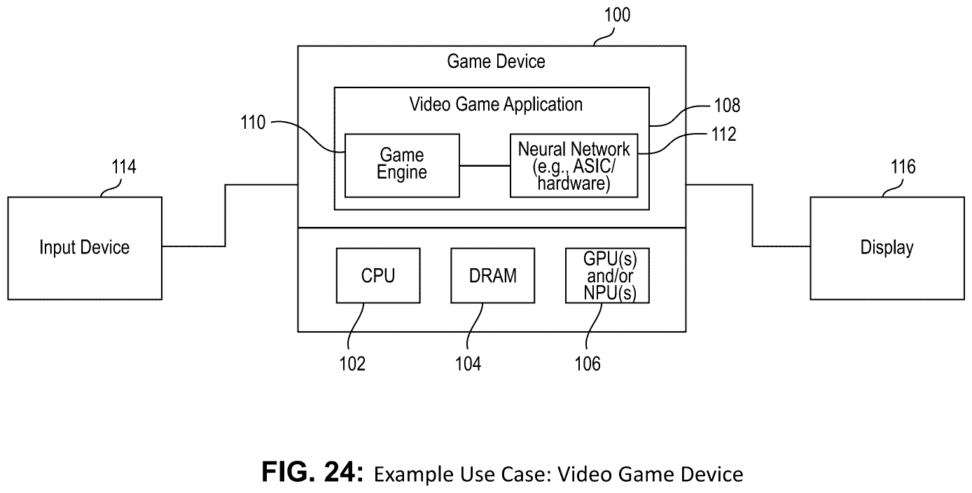

FIG. 24 shows a block diagram of an example computer apparatus (e.g., a video game system 100) that may be used by a user to play a video game and which is designed to operate as and/or contain a decoder 58. The system is configured to implement the decoding process described above. While the term “game” device is used in connection with certain example embodiments herein, this is done for ease of use and any type of computing device may be used. A “game” device as used herein may be a computing device (e.g., a mobile phone, tablet, home computer, etc.) that is being used (or will be used) to play a video game at that time. A non-limiting illustrative list of suitable computing devices may include, for example, a smart or mobile device (e.g., a smart phone), a tablet computer, a laptop computer, a desktop computer, a home console system, a video game console system, a home media system, and other computer device types. Computers can come in different sizes, shapes, functionality and the like. In certain example embodiments, the techniques discussed herein can be used in conjunction with a wide variety of non-game applications. For example, they may be used in conjunction with real-time video surveillance, web browsing, speech recognition, audio generation, electronic reading systems, sensing systems, transport systems, embedded processing systems, Internet of Things (IoT) devices, data archiving systems, information transmission and/or receiving systems, or other applications where data compression may be of use.

In this particular example, game devices 100 may include a CPU 102, a GPU 106, and DRAM (dynamic random-access memory) 104. CPU 102 and GPU 106 are examples of processors. DRAM 104 is an example of a memory device. Different types of CPUs, GPUs, DSPs, dedicated hardware accelerators (e.g., ASICs), NPU and memory technology (both volatile and non-volatile) may be employed on game device 100.

An example CPU comprises a multi-core, multi-threaded processing system capable of executing many execution threads concurrently. An example GPU comprises a massively parallel multi-core, multi-threaded processing system capable of performing graphics and compute workloads (which may include hardware support for matrix multiplications or tensor cores/accelerators) and integrated GPUs that may be found on a system on a chip (SoC). SoCs may combine two or more of the CPU 102, GPU 106 and local memory like registers, shared memory or cache memory (also called static RAM or SRAM) onto a single chip. DRAM 104 (also called dynamic RAM) is usually produced as a separate piece of semiconductor and connected to the SoC through wires. In certain examples, the processing capabilities provided by the CPU, memory components, GPU, and/or other hardware components that make up a given game device may be different on other game devices. Neural processing units (NPUs) may be used instead of or in combination with GPUs and/or CPUs. Some game devices may be mobile, some may be stationary game consoles, or operate as personal computers (e.g., a desktop or laptop computer system that is used to play video games).

Game device 100 may also be coupled to input device 114 and display device 116. Examples of input device 114 include video game controllers, keyboards, mice, touch panels, sensors and other components that may provide input that is used by the computer system (e.g., game device) to execute application programs and/or video games that are provided thereon.

Examples of display device 116 include an integrated display device or an external display device such as a television, a monitor, a casting display, a portable or handheld display, an augmented or virtual reality display such as glasses or goggles, etc. In certain examples, game device 100 may be configured to couple to different types of display devices. For example, game device 100 may be coupled to an integrated display (e.g., that is part of the structural body that houses game device 100) on which images may be output. Game device 100 may also be configured to output images to an external display. In certain example embodiments, the different display devices may natively display different resolutions.

Game device 100 stores and executes a video game application program 108. Included in the video game application program are a game engine 110 and a neural network 112. The game device 100 may also decode image data (e.g., textures), executable code, and other types of assets (e.g., sound, text, pre-rendered videos, etc.) that are used by the video game application program 108 and/or game engine 110 to produce or generate content for the video game (or other application) such as, for example, images for the game. Such assets may be included with a video game application program on a CD, DVD, or other physical media, or may be downloaded via a network (e.g., the Internet) as part of, for example, a download package for the video game application program 108. In example embodiments, any, some or all such assets are compressed and decompressed using the example embodiments herein.

The game engine 110 includes program structure to control a graphics or display pipeline within GPU 106 for generating images that are to be output to the display 116. For example, the GPU 106 graphics pipeline may include vertex mapping shaders, texture mapping shaders, lighting shaders, reflection shaders, shadowing shaders, rasterization hardware, ray tracing hardware, etc. See for example developer.nvidia.com/content/life-triangle-nvidias-logical-pipeline. The game engine 110 may include program structure for controlling the graphics pipeline to manage and update the position of an object(s) in a virtual space based on inputs provided from the input device 114. The provided data is then used to render an image of the virtual space by using, for example, a virtual camera. It will be appreciated that while a video game application program 108 is used for the purposes of description, other applications that provide video output could be substituted. While the neural network 112 is shown as being part of a video game application program 108, it may be separately provided. For example, it may be part of an operating system service or the like that modifies or upscales images as they are being output by a video game application program or it may be provided by different hardware implementing a deep neural network(s).

In certain example embodiments, the “game device” may be a device that is hosted within a cloud-based environment (e.g., on Amazon's AWS or Microsoft's Azure system). In such a scenario, the game (or other application program) may be hosted on a virtual machine in the cloud computer system and the input devices and display devices may be local to the user. The user may also have a “thin” client application or computer that is communicating with the cloud-based service (e.g., communicate data from the device and receive and display images that are received from the cloud to the television). In this type of implementation, user input is passed from the user's computer/input device to the cloud-based computer system that is executing the video game application 108. Images are generated by the game engine and then transmitted to the user's display (or a computer that then outputs the images to the display). In certain example embodiments, a cloud-based system may take advantage of the upscaling ability on the “thin” client by rendering, compressing and streaming compressed images to the client.

In certain example embodiments, the GPU may instead be (or include) an ASIC or NPU as noted above.

In certain example embodiments, game device 100 may be two or more computer systems such as a distributed computing system comprising multiple processing clusters that are remote to one another.

It will also be appreciated that the type of “application” or program or data source that is providing the source image is not confined to video games. Indeed, other types of applications may also make use of the techniques herein including real-time image recognition from a wildlife cam, audio, translation of words/sentences, images provided from a home security camera, movies and other TV programs, and the like.

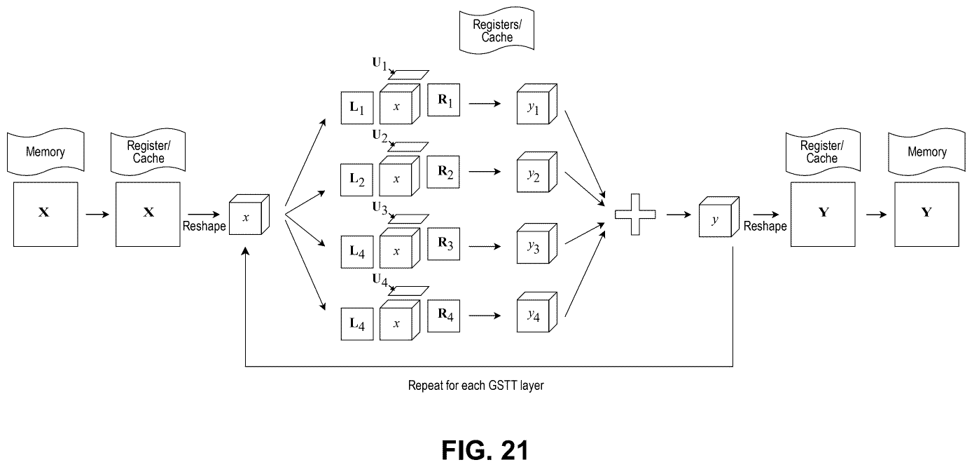

FIG. 21 shows an example implementation of a GSTT NN Predictor 1006, 1006′. In this example, input data X stored in a memory is transferred chunk by chunk to a register/cache and processed by register based operations one GSTT layer at a time. The results yᵢ of all GSTT term of the layer are summed to produce the output tensor y which is then reshaped, stored in registers/cache and output to a memory for further use, storage, transmission, etc.

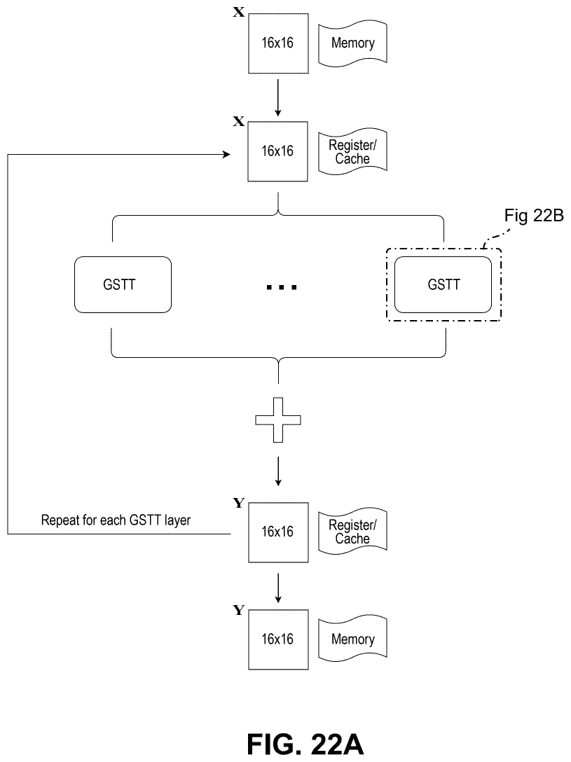

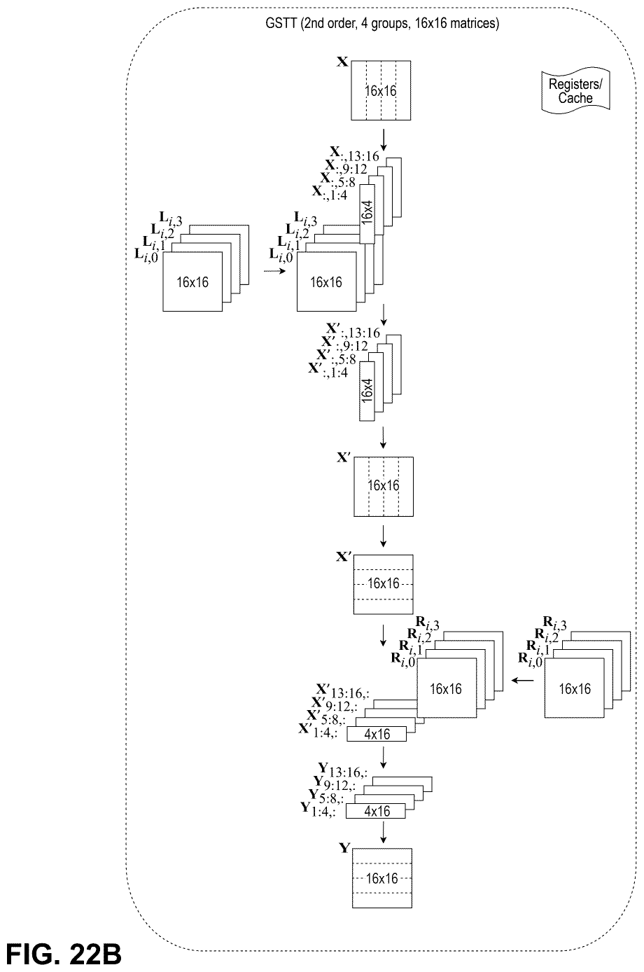

FIG. 22A shows an example higher level implementation in which the different GSTT layers can be processed in parallel by concurrent processing hardware and/or devices.

FIG. 22B shows an example sequence of matrix operations performed e.g., by MMA or tensor processors to transform a 16×16 X input to 16×16 Y output.

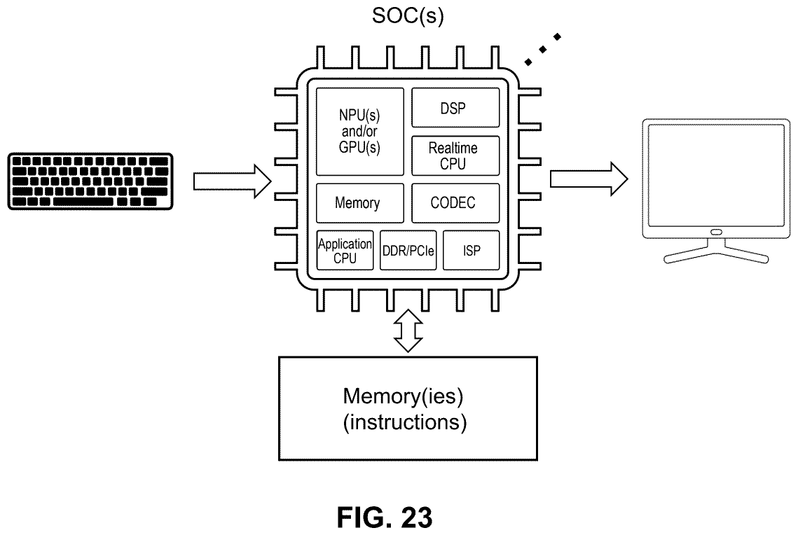

FIG. 23 shows an example SOC processing implementation including an input device (e.g., keyboard), and output device (e.g., display), a memory storing instructions, and an SOC including one or more CPUs, one or more GPUs and/or NPUs, one or more DSPs, one more internal memories, one or more CODECs, and other components such as an application CPU(s), an external memory interface, and a network interface. Such a processing implementation can perform the operations shown in FIGS. 21-23 using the NPUs and/or GPUs and/or the CODEC operating under the direction of the real-time CPU to encode and/or decode data as described above.

All patents and publications cited herein are incorporated by reference.

The scope(s) of protection provided by this patent are not to be limited to disclosed embodiments, but rather are to be defined by the spirit and scope of the claims.

### EXAMPLE HELPFUL REFERENCES

### Introduction to Kronecker Product:

KoPA: Automated Kronecker Product Approximation: //arxiv.org/pdf/1912.02392.pdf
The Ubiquitous Kronecker Product: //core.ac.uk/download/pdf/82128039.pdf

### Introduction to Tensor Decompositions:

Tensor Decompositions and Applications: //www.kolda.net/publication/TensorReview.pdf

Introduction to Tensor Decompositions and their Applications in Machine Learning://arxiv.org/pdf/1711.10781.pdf

### Separable Block Transform Patents:

Systems and methods for machine learned image conversion (U.S. Pat. No. 11,494,875B2)
Systems and methods for machine learned image conversion (U.S. Pat. No. 11,379,951B2)

### Related Work

Variational Tensor Neural Networks for Deep Learning: //arxiv.org/pdf/2211.14657.pdf
Compression of Fully-Connected Layer in Neural Network by Kronecker Product: https://arxiv.org/abs/1507.05775
Exploiting Local Structures with the Kronecker Layer in Convolutional Networks: https://arxiv.org/abs/1512.09194
Compressing RNNs for IoT devices by 15-38x using Kronecker Products: https://arxiv.org/abs/1906.02876
Compacter: Efficient Low-Rank Hypercomplex Adapter Layers: https://arxiv.org/abs/2106.04647
Tensor Contraction Layers for Parsimonious Deep Nets: https://arxiv.org/abs/1706.00439
Robust Kronecker Component Analysis: https://arxiv.org/abs/1801.06432
Tensor Regression Networks: https://arxiv.org/abs/1707.08308
Quantized Tensor Neural Network: https://dl.acm.org/doi/10.1145/3491255
Variational Tensor Neural Networks for Deep Learning: https://arxiv.org/abs/2211.14657
Tensor Networks Meet Neural Networks: A Survey and Future Perspectives: https://arxiv.org/abs/2302.09019

### Quantization:

### Introduction to Quantization-Aware Training:

Inside Quantization Aware Training: https://towardsdatascience.com/inside-quantization-aware-training-4f91c8837ead
Compressing models with Quantization: https://intellabs.github.io/distiller/quantization.html

### Related Work

Quantization and Training of Neural Networks for Efficient Integer-Arithmetic-Only Inference://arxiv.org/pdf/1712.05877.pdf
Trained Quantization Thresholds for Accurate and Efficient Fixed-Point Inference of Deep Neural Networks://arxiv.org/pdf/1903.08066.pdf
Power-of-Two Quantization for Low Bitwidth and Hardware Compliant Neural Networks://arxiv.org/abs/2203.05025
Energy Efficient Hardware Acceleration of Neural Networks with Power-of-Two Quantisation://arxiv.org/abs/2209.15257
DeepShift: Towards Multiplication-Less Neural Networks://arxiv.org/abs/1905.13298
SmoothQuant: Accurate and Efficient Post-Training Quantization for Large Language Models://arxiv.org/abs/2211.10438
GPTQ: Accurate Post-Training Quantization for Generative Pre-trained Transformers://arxiv.org/abs/2210.17323
AWQ: Activation-aware Weight Quantization for LLM Compression and Acceleration://arxiv.org/abs/2306.00978
SVDQuant: Absorbing Outliers by Low-Rank Components for 4-Bit Diffusion Models://arxiv.org/abs/2411.05007
BitNet: Scaling 1-bit Transformers for Large Language Models://arxiv.org/abs/2310.11453
The Era of 1-bit LLMs: All Large Language Models are in 1.58 Bits://arxiv.org/abs/2402.17764

1. A device comprising:
a processor or processing circuit to perform operations comprising:
reading an input file, and
training a neural network on the input file, the neural network being configured to provide flexible precision and flexible rank by summing an adjustable number of Grouped Separable Tensor Transform (GSTT) terms in each layer of the neural network, the training further configuring the trained neural network to output/infer output data from input data.

2. The device of claim 1 wherein the operations further include:
varying a number of GSTT terms across layers of the neural network to make a subset of the layers more expressive, and/or
configuring GSTT tensor order and precision across layers of the neural network, and/or
varying dimensions of STT matrices across GSTT layers of the neural network, and/or
varying dimensions of STT matrices within a same GSTT layer of the neural network, and/or
varying a number of GSTT groups across layers of the neural network, and/or
varying a number of GSTT groups within a same layer of the neural network, and/or
varying a number of layers of the neural network.

3. The device of claim 2 wherein all STT matrices of a same mode of a GSTT layer share a single quantization scale factor that is calculated through gradient-based optimization and quantized as a power-of-2 value.

4. The device of claim 1 wherein the adjustable number of GSTT terms for all layers of the neural network is set the same.

5. The device of claim 1 wherein the operations further include iteratively training the neural network using regularization & gradient-based optimization.

6. The device of claim 1 wherein the neural network is totally or partially quantized to integer power-of-2 values.

7. The device of claim 2 wherein the neural network represents an underlying fully-connected network that is sparse both in terms of rank and precision, and expressivity of the neural network is flexibly controlled by a single number K of GSTT terms in each layer of the neural network.

8. The device of claim 1 wherein the neural network receives an image as input and is trained to output an upscaled version of the image.

9. A device comprising:
a processor to perform operations comprising:
receiving input data;
using a hardware-circuit-based neural network to infer data from the received input data, the hardware-circuit-based neural network being configured to provide flexible-precision and flexible rank by summing an adjustable number of Grouped Separable Tensor Transform (GSTT) terms in each layer of the hardware-circuit-based neural network; and
outputting the inferred data or data derived therefrom.

10. The device of claim 9 further including:
varying a number of GSTT terms across layers of the hardware-circuit-based neural network to make a subset of the layers more expressive, and/or
configuring GSTT tensor order and precision across layers of the hardware-circuit-based neural network, and/or
varying dimensions of STT matrices across GSTT layers of the hardware-circuit-based neural network, and/or
varying dimensions of STT matrices within a same GSTT layer of the hardware-circuit-based neural network, and/or
varying a number of GSTT groups across layers of the hardware-circuit-based neural network, and/or
varying a number of GSTT groups within a same layer of the hardware-circuit-based neural network, and/or
varying a number of layers of the hardware-circuit-based neural network.

11. The device of claim 9 wherein the adjustable number of GSTT terms is set the same for all layers of the hardware-circuit-based neural network.

12. The device of claim 9 wherein the hardware-circuit-based neural network is totally or partially quantized to integer power-of-2 values.

13. The device of claim 9 wherein the hardware-circuit-based neural network is multiplication-free and performs integer-only arithmetic operations.

14. The device of claim 9 wherein the hardware-circuit-based neural network represents an underlying fully-connected network that is sparse both in terms of rank and precision, and expressivity of the hardware-circuit-based neural network is flexibly controlled by a single number K of GSTT terms in each layer of the hardware-circuit-based neural network.

15. The device of claim 9 wherein the hardware-circuit-based neural network receives an image as input and outputs an upscaled version of the image.

16. The device of claim 9 wherein the device comprises an application specific integrated circuit and/or a central processing unit and/or a graphics processing unit and/or a neural processing unit.

17. A method comprising performing, with a processor or processing circuit, operations comprising:
reading an input file, and
training a neural network on the input file, the neural network being configured to provide flexible precision and flexible rank by summing an adjustable number of Grouped Separable Tensor Transform (GSTT) terms in each layer of the neural network, the training further configuring the trained neural network to output/infer output data from input data.

18. The method of claim 17 wherein the operations further include:
varying a number of GSTT terms across layers of the neural network to make a subset of the layers more expressive, and/or
configuring GSTT tensor order and precision across layers of the neural network, and/or
varying dimensions of STT matrices across GSTT layers of the neural network, and/or
varying dimensions of STT matrices within a same GSTT layer of the neural network, and/or
varying a number of GSTT groups across layers of the neural network, and/or
varying a number of GSTT groups within a same layer of the neural network, and/or
varying a number of layers of the neural network.

19. The method of claim 18 wherein all STT matrices of a same mode of a GSTT layer share a single quantization scale factor that is calculated through gradient-based optimization and quantized as a power-of-2 value.

20. The method of claim 17 wherein the adjustable number of GSTT terms is set the same for all layers of the neural network.

21. The method of claim 17 wherein the operations further include iteratively training the neural network using regularization & gradient-based optimization.

22. The method of claim 17 wherein the neural network is totally or partially quantized to integer power-of-2 values.

23. The method of claim 17 wherein the neural network represents an underlying fully-connected network that is sparse both in terms of rank and precision, and expressivity of the neural network is flexibly controlled by a single number K of GSTT terms in each layer of the neural network.

24. The method of claim 17 wherein the neural network receives an image as input and is trained to output an upscaled version of the image.
